(19) United States
(12) Patent Application Publication
(10) Pub. No.: US 2009/0051486 A1
(43) Pub. Date: Feb. 26, 2009

(54) ELECTRONIC KEY CONTROL AND MANAGEMENT SYSTEM FOR VENDING MACHINES AND THE LIKE

(75) Inventors: William D. Denison, North Barrington, IL (US); Calin V. Roatis, Long Grove, IL (US); Gary L. Myers, Monee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Micro Enhanced Technologies, Inc, Wood Dale, IL (US)

(21) Appl. No.: 12/261,843

(22) Filed: Oct. 30, 2008

Related U.S. Application Data
(63) Continuation of application No. 11/185,110, filed on Jul. 20, 2005.
Application No. 11/185,110 is a continuation-in-part of application No. 11/010,661, filed on Dec. 13, 2004, now Pat. No. 7,373,352.
Application No. 11/010,661 is a continuation-in-part of application No. 10/838,449, filed on May 4, 2004.
Application No. 10/838,449 is a continuation-in-part of application No. 10/329,626, filed on Dec. 26, 2002, now Pat. No. 6,900,720.
(60) Provisional application No. 60/528,831, filed on Dec. 11, 2003.
(60) Provisional application No. 60/344,221, filed on Dec. 27, 2001.

(51) Int. Cl. G06K 19/00

(52) U.S. Cl. 340/5.25; 340/5.9

(57) ABSTRACT

A mobile electronic control device, such as an electronic key, is used to access or otherwise control the operations of a field device, such as an appliance, power tool, shipping container, etc. In a control event in which the mobile control device interacts with the field device via wired or wireless communications, the control device obtains the current location and the field device ID. The communications between the mobile control device and the field device may be secured with encryption. The location information is used by the mobile control device to determine whether the field device should be accessed or enabled. Alternatively, the location information may be stored separately in a location sensing device, and the control event data recorded by the key and the location information recorded by the location sensing device are later combined when they are downloaded into a management system for auditing.

### CROSS-REFERENCE TO RELATED APPLICATIONS

This patent application is a continuation of U.S. application Ser. No. 11/185,110, filed Jul. 20, 2005, which is a continuation-in-part of (1) U.S. application Ser. No. 11/010,661, filed Dec. 13, 2004, which claims the priority of U.S. Provisional Application 60/528,831, filed Dec. 11, 2003, and (2) U.S. application Ser. No. 10,838,449, filed May 4, 2004, which is a continuation-in-part of U.S. application Ser. No. 10,329,626, filed Dec. 26, 2002, which claims the priority of U.S. Provisional Application No. 60/344,221 filed Dec. 27, 2001. All of the foregoing references are herein incorporated by reference for all that they teach without exclusion of any part thereof.

### FIELD OF THE INVENTION

This invention relates to electronic devices for accessing or otherwise controlling functions of devices that operate in the field (“field devices”), such as vending machines, coolers, fountain dispensers, storage boxes, shipping containers, power tools, etc., and more particularly to a system and method for controlling and managing operations of field devices that collects location information of the field devices and uses the location information and other parameters for controlling the operations of the field devices.

### BACKGROUND OF THE INVENTION

Appliances, such as vending machines, fountain drink dispensers, coolers, etc., are used in various commercial settings, and there is always a need to control access to or operations of those devices. For instance, vending machines have to be serviced on a regular basis to replenish goods and collect money, and it is necessary to control the access to the machines so that only authorized personnel may open the machines at allowed times. As another example, it may be desirable to control the operation of a given appliance, such as a fountain drink dispenser, such that the appliance cannot be used unless the authorization for its usage is renewed. Moreover, in many cases, it is desirable to be able to monitor the location of an appliance such that its access or usage can be denied if the appliance has been stolen or otherwise removed from its intended location. Similar needs to control the access and operations of other devices used in the field, such as power tools, storage boxes, shipping containers, etc., based on various parameters such as time, location, number of access, personnel authorization, etc., are also felt in many different industries.

### BRIEF SUMMARY OF THE INVENTION

It is a general object of the invention to provide a system and method for accessing or controlling operations of devices in the field that enables the use of location information to determine whether a field device should be accessed or enabled to operate based on the location and other operation limit parameters.

In accordance with the invention, a mobile control device, such as an electronic key, is used to access or otherwise control the operations of a field device, such as a vending machine, fountain drink dispenser, power tool, storage or shipping container, etc. In a control event in which the mobile control device interacts with the field device to apply the control, the control device receives location information and the ID of the field device, and uses the location data in determining whether the field device should be accessed or enabled. The communication between the mobile control device and the field device may be secured with encryption. The mobile control device may record the location information and the device ID in a control event record which may be later downloaded for auditing. Alternatively, the time-dependent location information may be stored separately in a location sensing device. The control event data and the location information are then downloaded into a management system and combined therein.

Other objects and advantages of the invention will become clear from the detailed description of embodiments with reference to the drawings, of which:

### BRIEF DESCRIPTION OF THE SEVERAL VIEWS OF THE DRAWING(S)

FIG. 1 is a schematic view of a vending machine and an electronic key for opening an electronic lock inside the vending machine;

FIG. 2 is a perspective view of an electronic lock assembly mounted on a door of a vending machine;

FIG. 3 is a block diagram showing electronic circuit components of an electronic lock used in a vending machine;

FIG. 4 is a block diagram showing electronic circuit components of an electronic key;

FIGS. 5A and 5B are schematic diagrams showing key codes stored in the memories of an electronic key and an electronic lock, respectively;

FIG. 6 is a schematic diagram showing the transmission of data between an electronic lock on a vending machine and an electronic key during a simplified unlocking process;

FIG. 7 is a schematic diagram showing communications between an electronic lock on a vending machine and an electronic key during an unlocking process that has higher security than the process in FIG. 6;

FIG. 8 is a schematic diagram showing communications between an electronic lock on a vending machine and an electronic key during an unlocking process similar to that FIG. 7 but with a step of checking the lock ID for access control;

FIG. 9 is a schematic diagram showing a computer used to program operational limitations into an electronic key;

FIG. 10 is a schematic diagram showing the downloading of audit data from vending machines to an electronic key; and

FIG. 11 is a schematic diagram showing an example of audit data uploaded from a vending machine to an electronic key.

FIG. 12 is a flowchart showing the key code learning process of an embodiment of the electronic lock;

FIG. 13 is a flowchart showing an operation by an embodiment of the electronic key to back up the time and date for restoring the clock of the key in case of a faulty or removed battery;

FIG. 14 is a flow chart showing an operation by the electronic key to record the number of power-up of the key to prevent tampering by battery removal;

FIG. 15 is a schematic block diagram showing an embodiment of a vending machine that has a communication device that is interfaced to the electronic lock and in wireless communications with a home base for access control and auditing purposes;

FIG. 16 is a schematic diagram showing vending machines accessible by an electronic key that has a narrow wireless signal transmission pattern to avoid accidental opening of the vending machines;

FIG. 17 is a schematic diagram showing a system in which alternative programming schemes for programming the lock of a vending machine in the field may be implemented without requiring the vending machine to be opened before programming;

FIG. 18 is a schematic diagram showing data stored in the components in the system of FIG. 17;

FIG. 19 is a schematic diagram showing an embodiment in which a hand-held program unit is used to program the electronic lock of a vending machine;

FIG. 20 is a schematic diagram showing an alternative embodiment that also uses a hand-held program unit to program the electronic lock of a vending machine;

FIG. 21 is a schematic diagram showing another alternative embodiment in which an external computing device is used to remotely program the electronic lock of a vending machine and an electronic key is then used to access the lock;

FIG. 22 is a schematic representation of an embodiment of a key management system including a personal computer having a local database and software program, and cradle that functions as an interface for communications between an electronic key and the computer;

FIGS. 23A and 23B are schematic diagrams showing the user interface screen and process for registering the software and the cradle of the key management system;

FIGS. 24A, 24B and 24C are schematic diagrams describing a start-up and refresh sequence of the keys;

FIG. 25A is a schematic diagram showing user interface screens for a user to entering supervisor and administrator modes;

FIG. 25B is a flow chart showing a process for a user to enter electronic lock information;

FIG. 26A is a flow chart for a process of starting up or logging in new keys;

FIG. 26B is a schematic diagram showing user interface screens for the operation of entering key user information;

FIG. 27A is a schematic diagram showing a process of collecting electronic lock ID information;

FIG. 27B is a schematic diagram showing user interface screens for prompting a user of the key management system to enter information regarding a new electronic lock;

FIG. 27C is a schematic diagram showing an alternative process for collecting electronic lock ID information;

FIG. 28 is a flow chart describing a process of receiving and storing audit data;

FIG. 29 is a schematic diagram showing user interface screens for displaying audit trails data collected by electronic keys from vending machines;

FIGS. 30A and 30B are schematic diagrams showing user interface screens for a process of editing key limit operational parameters;

FIG. 30C is a flow chart showing a process of editing key limit parameters;

FIG. 31 is a flow chart showing a process of re-calculating key limit parameters during a key refresh operation;

FIG. 32 is a flow chart showing a process of refreshing the memory of an electronic key;

FIG. 33 is a schematic diagram showing a configuration of multiple key management databases that are synchronized using export files;

FIG. 34 is a schematic diagram showing a configuration with multiple key management stations connected via a network to a central key management database;

FIG. 35A is a schematic diagram showing a configuration of multiple key management stations connected to a central database with a database server;

FIG. 35B is a schematic diagram showing a configuration of key management stations at multiple remote separate locations connected to a central database server with multiple databases for the separate locations;

FIG. 36 is a schematic diagram showing a configuration with key management stations at different locations connected to a central database server through the Internet;

FIG. 37 shows user interface screens for generating an export file for synchronizing distributed databases;

FIG. 38 shows a user interface screen for setting software auto-exit and archive settings;

FIGS. 39-41 show user interface screens involved in scheduling the operation of the key management system for auto start up;

FIGS. 42 and 43 show user interface screens involved in setting the auto-exit time for the key management system;

FIG. 44 is a schematic diagram showing in functional blocks an electronic key that has a position sensing component for detecting the locating of the electronic key during field operation.

FIG. 45 is schematic diagram showing an appliance in the form of a fountain drink dispenser that is to be enabled using a mobile control device such as an electronic key;

FIG. 46 is a data flow diagram showing a secured communication process between a controller of the appliance and the key for enabling the operation of the appliance;

FIG. 47 is a data flow diagram showing an alternative communication process between the appliance controller and the key;

FIG. 48 is a functional block diagram showing the components of the appliance controller;

FIG. 49 is a flow diagram showing a process performed by the appliance controller for controlling the operation of the appliance;

FIG. 50 is a schematic diagram showing an embodiment with an appliance in the form of a cooler;

FIG. 51 is a schematic diagram showing an embodiment in which a field device being controlled is in the form of a secured container.

FIG. 52 is a schematic diagram showing an embodiment in which a field device being controlled is a power tool;

FIG. 53 is a schematic diagram showing an alternative embodiment in which location data recorded by a location sensing device are combined with access/control event records stored in a mobile control device; and

FIG. 54 is a schematic diagram showing a location sensing device, such as a GPS receiver, received in a cradle in a transportation vehicle.

### DETAILED DESCRIPTION OF THE INVENTION

Referring now to the drawings, the present invention is directed to an electronic system and method for controlling the access events and operations of devices used in the field. Generally, devices operating in the field are in a relatively unsecured environment, and it is necessary to control the access or usage of the devices so that they are not accessed by unauthorized persons or that they are not used at unauthorized times or places. The field devices that may be advantageously controlled using the system and method of the invention include, for example, appliance devices such as vending machines, coolers, fountain drink dispensers, etc., power tools used in construction sites, shipping containers, and many other types of devices. It will be appreciated that the above list is meant only to provide some examples of field devices and is by no means intended to limit the applicability of the invention.

By way of example, the following description begins with a system and method for an embodiment in which the field devices are vending machines. It will be appreciated that the operative principles of the invention described in connection with this embodiment can be applied to other field devices, as will be described in greater detail below.

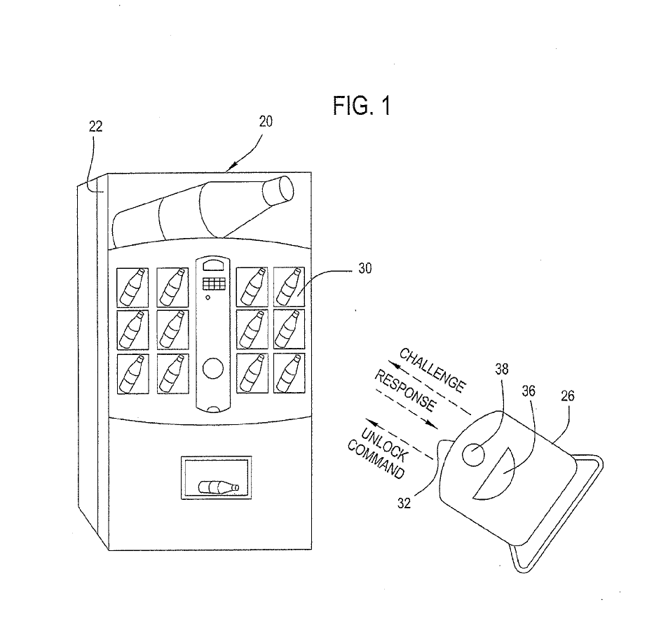

As will become clear from the following description, the embodiment of the invention implemented for use with vending machines provides significantly improved security and ease of management over conventional vending machines equipped with mechanical locks. The term “vending machine” as used herein means a device that performs a money transaction, which may involve the insertion of cash or commercial paper, or the swiping of a credit and/or debit card, and may (but not required to) dispense an item or items or provide functions in response to the money transaction. In this regard, this term is meant to cover broadly machines commonly used for vending drinks and snacks, ATM stations, change machines, toll machines, coin-operated laundry machines, video arcades, etc. FIG. 1 shows, as an example, a vending machine 20 with an embodiment of an electronic lock mounted therein. The vending machine 20 has a front panel 22 or door that can be opened when the electronic lock is unlocked with a properly programmed electronic key 26. It will be appreciated that the vending machine and the electronic key are not shown to scale in FIG. 1, and the view of the electronic key is significantly enlarged with respect to the vending machine to show its features.

The key 26 and the lock preferably communicate with each other wirelessly, which may be via an infrared or radio frequency (RF) channel. In a preferred embodiment, the wireless communications between the key and the lock is via infrared transmissions. The infrared medium is preferred because it is directional and short range, and the infrared circuitry in the lock is not sensitive to the metal cabinet enclosure of the vending machine. Thus the vending machine will less likely be opened accidentally if the key is accidentally operated of if the key is operated to unlock another vending machine nearby. In addition, the infrared light can travel through the selection buttons on the vending machine. This allows the infrared transceiver of the electronic lock to be positioned behind a selection button 30 of the vending machine, as illustrated in FIG. 1. To that end, the vending machine 20 has an infrared transceiver disposed to receive infrared transmission through its front panel 22, and the electronic key 26 has an infrared transceiver at one end 32. As shown in FIG. 1, in one implementation, the electronic key 26 has a very simple profile, having only a “START” button 36 that can be activated by a user for lock opening and key code learning operations. In a preferred embodiment, the “START” button 36 need not be continuously pressed in order for the key to transmit the encrypted code to the lock. Instead, the user only has to only momentarily press the button 36, and the key will automatically stop transmitting after a few seconds, thus the key will not transmit indefinitely and deplete the battery if the button is stuck down. The electronic key 26 also has a light-emitting diode (LED) 38 exposed through a hole in the housing of the key for indication the operation status of the key.

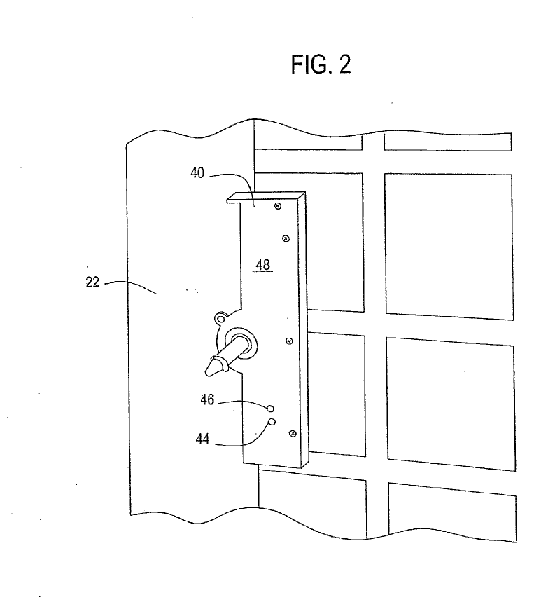

In accordance with an aspect the embodiment, the electronic lock assembly is mounted inside the vending machine 20 to prevent unauthorized access and tampering. It can be physically accessed only when it is properly unlocked and the door 22 or front panel of the vending machine is opened. In one embodiment, as shown in FIG. 2, the electronic lock assembly 48 is mounted on the inside of the door 22, and opening the door of the vending machine exposes the lock assembly housing 40. The electronic lock 48 includes a lock shaft 42 that engages into a corresponding receptacle in the body of the vending machine to prevent the door from being opened when it is in a locked position. The electronic circuit of the lock resides in the housing 40 of the lock assembly. The housing 40 has two holes. Behind one hole 44 is a “LEARN” switch connected to the electronic lock circuit. This switch can be accessed and pressed down with a thin object, such as a screwdriver or a car key. Behind the other hole 46 is a light-emitting diode (LED), which servers as a means for providing an indication of the operational state of the electronic lock during a key code learning operation or a lock opening operation, as will be described in greater detail below.

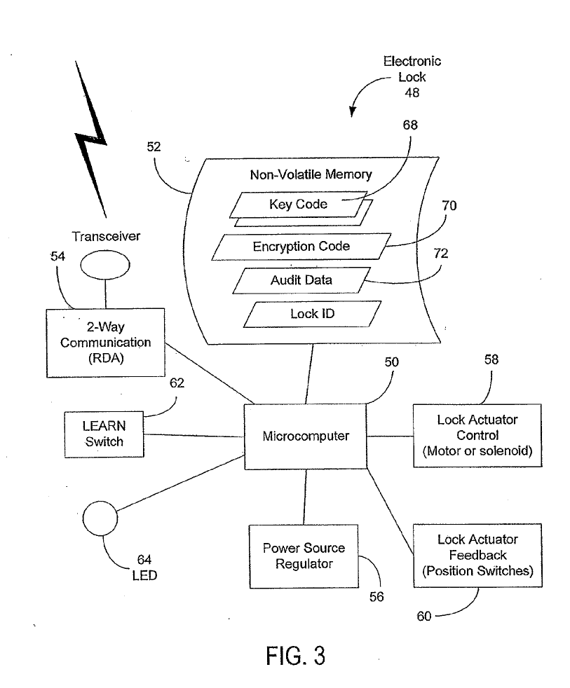

Turning now to FIG. 3, in one embodiment, the circuit of the electronic lock 48 comprises a microcomputer 50, a non-volatile memory 52, a half-duplex IRDA infrared communication interface 54 for communicating with an electronic key, a power supply voltage regulator 56, a lock motor or solenoid control circuit 58, position feedback switches 60, a learn switch 62 as mentioned above, and the LED 64 for state indication. The non-volatile memory is for storing key codes 68, encryption codes 70, and audit data 72, as will be described in greater detail below.

In an alternative embodiment, the vending machine with the electronic lock is to be accessed using a mechanical key rather than an electronic key. To that end, the electronic lock includes an interface to a combination (the “switch-lock” combination) of an electrical switch 74 and a mechanical lock 76 that has a cam for moving the switch into a closed or open position. The electrical switch 74 is normally in an open state and is closed when the mechanical lock 76 is opened using an associated mechanical key 78. The open/close state of the switch 76 is detected by the microcomputer 50 and is used to determine whether the mechanical lock 76 is opened or closed. The microcomputer 50 is programmed to unlock the door 22 of the vending machine 20 in response to the closing of the switch contact caused by unlocking of the mechanical lock 76 using the mechanical key 78. Thus, the unlocking process does not involve the passing of a key code between the electronic lock and an electronic key. Accordingly, as described in greater detail below, during a learning process, the electronic lock learns that it is to be accessed using a mechanical key instead of an electronic key with a key code.

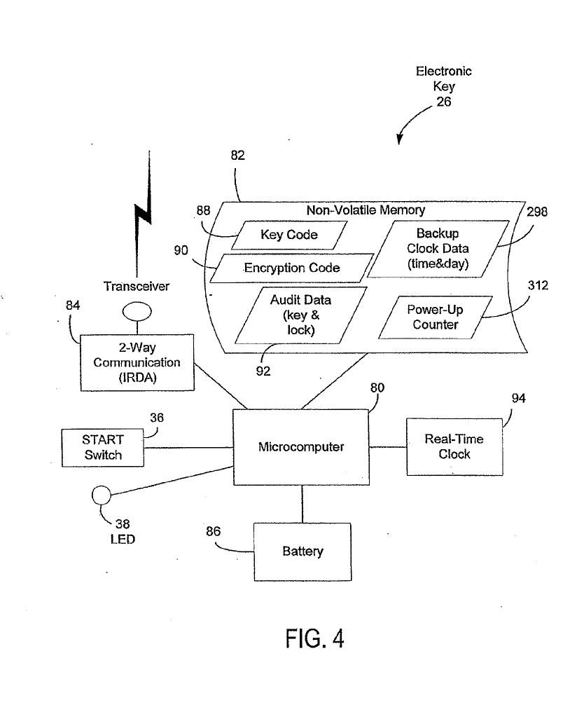

As shown in FIG. 4, in one embodiment, the electronic key 26 includes a microcomputer 80, a non-volatile memory 82, a half-duplex IRDA infrared communication interface 84 for communicating with the electronic lock of a vending machine or with a computer for programming the key, a power source (e.g., a battery) 86, a real-time clock integrated circuit (IC) 94 for generating data indicating the date and time, and the “START” switch 36 and the LED light 38 as mentioned above. The non-volatile memory 82 is for storing a key code 88, encryption codes 90, and audit data 92 generated by the key and/or downloaded from vending machines operated using the key, as will be described below.

The key codes in the keys and the locks of the vending machines are used to define the security and access control strategy of the electronic lock system. Each electronic key 26 has a key code 88 stored therein, and the same key code is stored in the memory 52 of the electronic lock in each vending machine to be operated with the electronic key. During each access attempt, the key code in the electronic key is transferred from the key to the electronic lock using a secured communication method. The electronic lock can be unlocked if the key code it receives from the electronic key matches the key code stored in the memory of the lock.

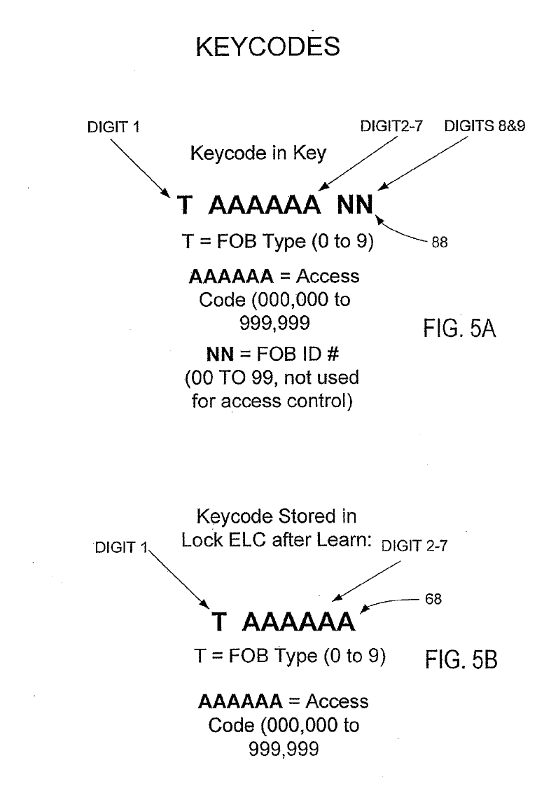

In one implementation as shown in FIG. 5A, a key code 68 stored in an electronic key includes seven (7) digits. The first digit of the key code is used to indicate the type of the key. As the value of the key-type digit may go from 0 to 9, there may be up to 10 total key types. As will be described below, in one embodiment of the electronic lock system, there are three different key-types: low-security key, standard key, and auto-tracking-key, which correspond to different levels of security in lock-opening operation and audit data collection. The next 6 digits in the key code are the access code (000,000 to 999,999). In addition to the 7 digits representing the key type and access code, a key code stored in the electronic key additionally includes two lower digits, which may be used as the identification (ID) code of that key. In this example, the key ID may vary from 0 to 99. Thus, there may be up to 100 keys that have the same key type and access code but different key ID numbers.

Similarly, as shown in FIG. 5B, a key code 68 stored in the electronic lock has seven (7) digits. The first digit indicates the key type, and the remaining 6 digits are the access code. As mentioned above, there may be up to 10 different key types, and the electronic lock may be programmed to accept a number of key codes of different key types.

In accordance with a feature of the embodiment, the electronic lock 48 of the vending machine 20 is field-programmable. In other words, the key code or key codes of the electronic lock 48 can be programmed (or “learned”) into the non-volatile memory 52 of the lock after the vending machine has been installed in a given location. In a preferred embodiment, the electronic keys to be used to operate the vending machines are programmed with a permanent key code at the factory and ordered by the users of the electronic locks. In the example given above, the users may order up to 100 keys with the same access code. In contrast, the electronic locks to be used in the vending machines are not programmed with any customer-specific key code. Instead, the electronic locks are programmed with a universal code at the factory. The “universal code” is the code put in the lock by the manufacturer of the lock or the vending machine, and is used by the customers to unpack and open the machines after they receive the machines. Thereafter, the electronic locks are installed in the vending machines, which are then shipped to and set up at their respective operating places. In accordance with an aspect of the embodiment, the access control strategy is established by “learning” or transferring the access code of the electronic key to be used to operate the machine into the electronic lock via a secured transfer process.

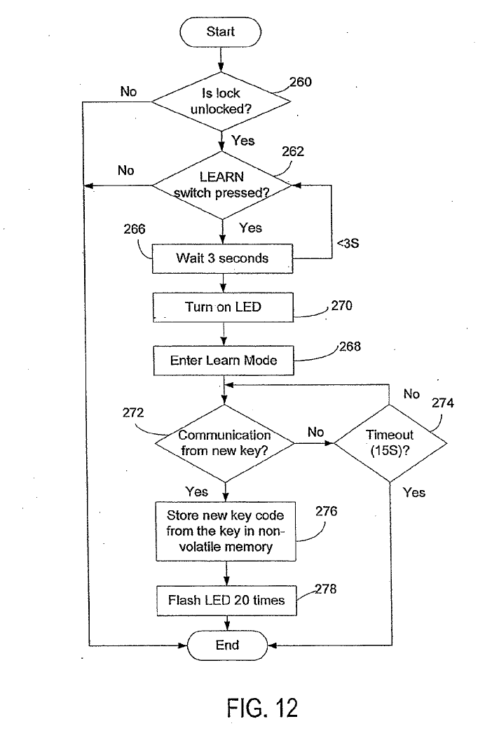

Referring back to FIGS. 1-3 and 12, in one embodiment, to make the electronic lock 48 learn the access code from an associated electronic key 22 or that it is to be controlled by a switch-lock, the service person has to gain access to the LEARN switch 62 of the lock. In addition, it is preferred that the lock microcomputer senses, using the position switches 60, that the lock is in the unlocked position to allow entering into the “learn” mode (step 260 in FIG. 12). To that end, if the door 22 of the vending machine is originally closed and the lock contains the universal key code programmed at the factory, the service person uses a key containing the universal key code to unlock the vending machine and open the door to gain access to the LEARN button of the lock. As mentioned above, the LEARN switch 62 should be at a secured location such that it can be accessed only when the lock is properly unlocked (as opposed to a forced entry) and when the door is open. An assumption in the access control strategy is that an authorized person is servicing and/or reprogramming the lock if the door is properly unlocked and opened. If the microcomputer 50 detects (step 262) that the LEARN switch 62 is pressed (e.g., held for longer than three seconds), it waits (step 266) for the switch to be held in that position for a pre-selected time period (e.g., 3 seconds) and then enters a LEARN process (step 268). In response to the pressing of the learn button, the LED 64 is turn on (step 270). In alternative embodiments, the LEARN switch 62 can be substituted by another activation means that provides a greater level of security, such as a keypad for entering a service authorization code or an electromechanical switch lock that requires a mechanical or another electronic key.

Once the lock 48 is put in the LEARN mode, the service person operates the electronic key 22 containing the desired key code by pressing the button 36 on the key. This causes the key 22 to transmit the key code stored in its memory to the electronic lock. If the electronic key and the lock employ encryption techniques in their communications, the electronic key 22 first encrypts the key code 88 with the encryption codes 90 in its non-volatile memory and then transmits the encrypted code.

The service person is given a pre-selected timeout period (e.g., 15 seconds) to press the key to transmit the key code. To that end, the lock 48 determines whether it has received the transmitted key code (step 272). If it determines (step 274) that a key code transmission is not received within the timeout period, the learning process is terminated. If a key code has been transmitted within the timeout period, the electronic lock 48 receives the transmitted key code via its receiver port 30. If the transmitted code is encrypted, the electronic lock decrypts the received data with the encryption codes 72 in its memory 52. In a preferred embodiment, the encryption codes in the electronic key and the electronic lock are inserted during manufacturing at the factory, and different encryption codes may be used for different vending machine owners (e.g., different soft drink bottlers) so the keys given to one owner may not be learned into and used to access the vending machines of another owner.

If the encryption codes of the key and the lock do not match, the electronic lock will not be able to successfully decrypt the received key code. In that case, the process will end and the lock will not learn the new key code. If, however, the decryption was successful, the lock stores the key code at a proper location in its non-volatile memory 52 according to its key type (step 276). After verifying that the key code is stored correctly in the proper key type location, the lock 48 provides a signal to the service person by flashing the LED 64 to indicate that the LEARN process is successfully completed (step 278). From this point forward, the electronic lock will use the newly learned key code for access control. In other words, it will compare this key code with the key code transmitted from an electronic key to determine whether the door should be unlocked. If there was a key code of the same key type previously stored in the memory 52 prior to the LEARN operation, that old key code will be erased and can no longer be used to access the vending machine.

As mentioned above, in an alternative embodiment, the vending machine equipped with the electronic lock may be accessed with a mechanical key rather than an electronic key. The electronic lock learns that it is to be controlled by the combination of the electrical switch 74 and the mechanical lock in a learning process similar to the one for learning a key code as described above. Specifically, to enable the lock access via the switch-lock, the service person puts the electronic lock into the learn mode by pressing the LEARN switch 62 as described above. Once the electronic lock 48 is in the learn mode, the service person uses the mechanical key 76 to unlock the mechanical lock 76. When the mechanical lock 76 is moved to its unlocked position, its cam closes the contact of the electrical switch 74. The microcomputer 50 of the electronic lock receives the contact-closure signal (i.e., detecting that the electrical switch is closed) and treats the signal as indication that the vending machine is to be accessed using a mechanical key. In response, the microcomputer set its operation mode such that in the future it will unlock the door of the vending machine in response to detecting the closure of the contact of the electrical switch 74. Thus, from this point forward, the vending machine is accessed using the mechanical key 78, which replaces one or more types of electronic keys.

It will be appreciated that the key learning process described above does not require changing or replacing any physical components of the lock. If the electronic key for operating the lock on the vending machine is stolen or lost, the service person will first use a back-up key that has the key code of the key that is lost, or a key that has a different key code that has been previously learned into the lock, to open the door. The service person then uses the key learning process described above to change the key code in the memory of the lock to a new value. This field-programmability of the electronic lock makes key management significantly easier and cost-effective, and provides a greater level of key security compared to mechanical keys. In contrast, with conventional vending machines using mechanical locks, the mechanical keys may be copied or stolen easily, and the entire lock core of each of the vending machines affected has to be replaced in order to change to a different key.

In the illustrated embodiment, one digit in each key code stored in the lock indicates the type of the key, and there may be up to ten different key types. A lock is able to learn one key code for each allowed key type. A key code of a first type may be that learned from a “primary” electronic key for the vending machine, while a key code of a second type may correspond to a different electronic key, such as a “master” key that can be used as a back-up in case the primary key is lost, stolen, broken, or otherwise unavailable.

In a preferred embodiment, as briefly mentioned above, different types of electronic keys (indicated by the different values of the key type digit) are provided that correspond to different levels of security (and the associated complexity of communication) and audit data collection function. The three types of electronic keys are economy key, standard key, switch-lock, and auto-tracking key. The operation of each of these three types of keys is described below.

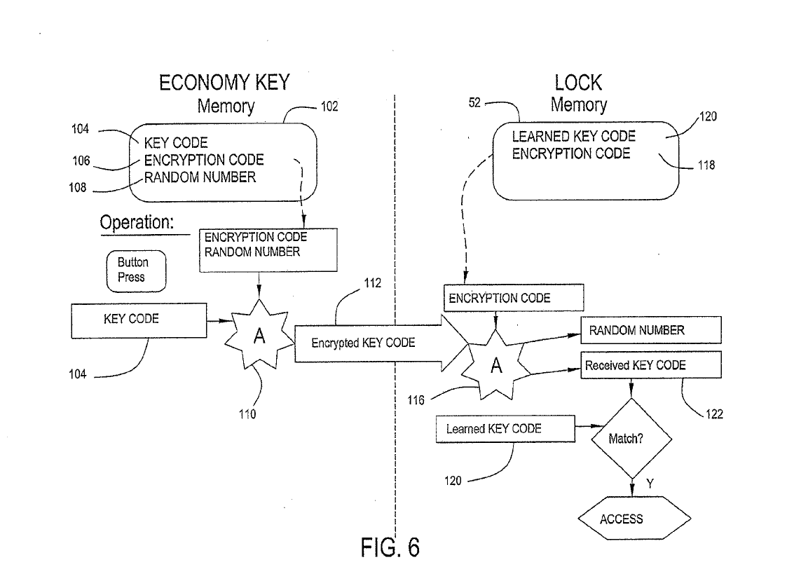

Referring to FIG. 6, the economy key employs a simple one-way communication process for interacting with a corresponding electronic lock on a vending machine. Since the communication process is simpler and the one-way communication does not require a receiver in the key, the key can be build at a lower cost. As shown in FIG. 6, the memory 102 of the economy key contains a key code 104, an encryption code 106, and a random number 108. In a preferred embodiment, the key starts with a given value of the random number, and the random number changes every time the key cycles through a key code transmission. When a user activates the key by pressing the button on the key, the key uses the encryption code to encrypt (step 110) the key code 104 together with the random number 108, and transmits the encrypted number 112 to the electronic lock. When the electronic lock receives the transmitted encrypted data, it decrypts (step 116) the data with the encryption code 118 in its memory 52. The lock then retrieves the key code 122 from the decrypted data and compares it with the key code 120 of the same type in its memory. If the two key codes do not match, the process ends. If they match, the electronic lock proceeds to unlock the door of the vending machine.

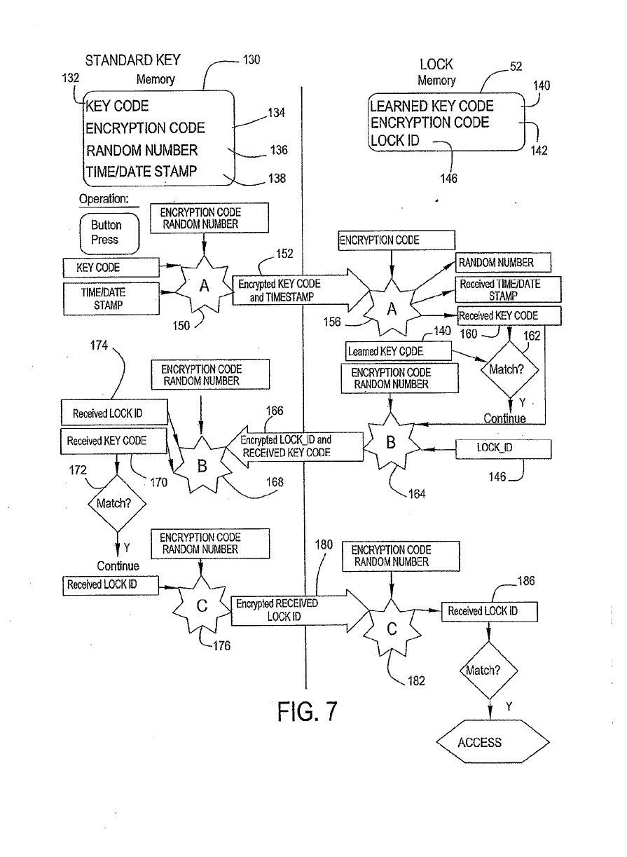

In comparison with the economy key, the standard key provides a more secure unlocking process that requires 2-way encrypted communications between the key and the electronic lock. The 2-way communications is in the form of a bi-directional challenge-response process. Referring to FIG. 7, the memory 130 of the key contains the key code 132, the encryption code 134, a real-time clock timestamp 136, and a random number 138. Similarly, the memory 52 of the electronic lock of the vending machine contains a learned key code 140, the encryption code 142, and an ID 146 of the electronic lock. When the service person presses the transmission button on the electronic key, the electronic key encrypts (step 150) the key code 132 in its memory together with the time stamp 136 and the random number 138, and transmits the encrypted key code and timestamp to the electronic lock of the vending machine. The electronic lock receives the transmitted data 152 through its infrared communication interface and decrypts (step 156) the received data with the encryption code 142 in its memory. Next, the electronic lock compares (step 162) the decrypted key code 160 with the key code 140 of the same type in its memory. If the two key codes don't match, the process ends, and the door will not be unlocked. In that case, the electronic lock sends a code to the key to indicate that the key has tried an incorrect key code.

If the two key codes match, the process continues and enters a second phase in which the electronic lock transmits data to the electronic key. Specifically, the lock encrypts (step 164) the key code, the lock ID 146, and the random number. It then transmits the encrypted key code, lock ID, and the random number (originally sent by the key) to the electronic key. The electronic key receives the encrypted data 166 and decrypts (step 168) the data to retrieve the key code and the lock ID. If the key determines (step 172) that the key code 170 returned by the lock matches the key code 132 in the memory of the key, it stores data regarding the access event, including the lock ID, in an audit trail data portion of the key's memory for audit purposes.

The key then proceeds to the third phase of the unlocking process, in which the key communicates to the lock to allow access. To that end, the key encrypts (step 176) the received lock ID and transmits the encrypted lock ID and random number to the lock. The lock receives the transmitted data 180 and decrypts (step 182) the data to retrieve the lock ID. If the received lock ID 186 matches the lock ID 146 stored in the memory of the lock, the microcomputer of the lock proceeds to unlock the door of the vending machine.

The unlocking operation described above has several advantages. It allows the transfer of the lock ID and the key codes between the electronic key and the lock on the vending machine without repeating numbers or a distinguishable pattern of numbers in case of eavesdropping of repeated access attempts. It also prevents a transfer of data between the key and the lock with different encryption codes. Further, it provides a consistent and secure means of data transfer between the key and the lock for a condition where many keys with the same key code will be expected to communicate with many locks on different vending machines containing that key code. This bi-directional challenge-response encryption scheme provides no risk of the keys and the locks going out of sequence, which is a common problem with unidirectional rolling-code encryption systems.

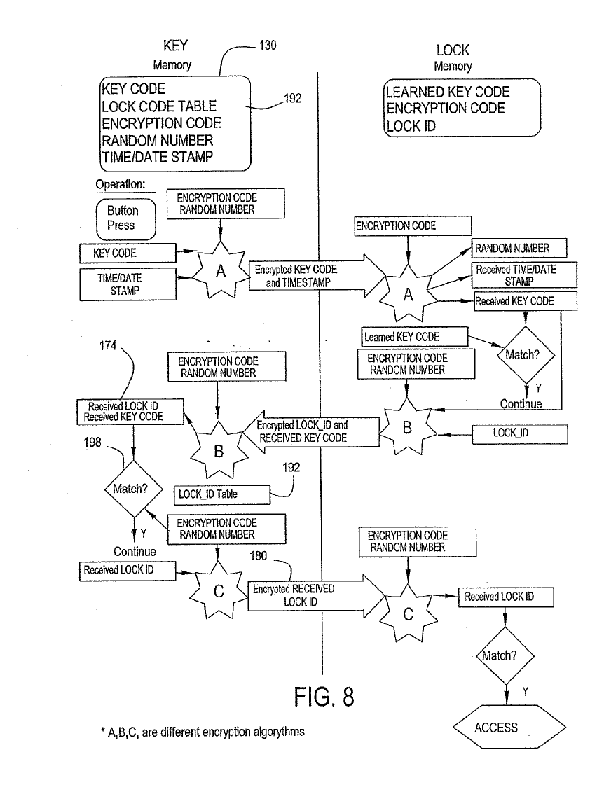

The lock ID code is used in the unlocking operation described above for generating audit data for audit trail identification purposes and also for data transfer encryption purposes. In an alternative embodiment, however, it is also be used to provide a method for controlling which vending machines a key is allowed to access. In this method, there may be many keys containing the same key code, and there may be many vending machines that have “learned” the same key code. It is possible, however, to specify which vending machines a given key is allowed to access so that a single key cannot open all the vending machines. Referring to FIG. 8, this is accomplished by loading a list of lock ID codes 192 into the memory 130 of that key prior to operation. During an unlocking operation, the key receives a lock ID 174 from the electronic lock on the vending machine and compares the received lock ID with the list of lock IDs 192 in its memory. Only if it is determined (step 198) that the received lock ID 174 matches one of the lock IDs in the list will the key proceed to send the unlock command signal (e.g., the transmission 180 in the third phase) to the electronic lock. As shown in FIG. 8, the unlocking process is otherwise similar to that shown in FIG. 7. This method of access control provides supervisors of the operation the flexibility of allowing or disallowing a given key to access selected vending machines.

In an alternative embodiment, an electronic key may also be programmed with other types of limits of operation of the key. For instance, the key may be programmed with limit registers that contain values chosen by a supervisor to limit the operation of that particular key.

In a preferred embodiment, the limit registers 200 (FIG. 4) are part of the non-volatile memory 52. The operation limits include, for example, time of data, date, number of days, number of accesses, number of accesses per day, etc. When the user of the key presses the button on the key to initiate a key code transmission, the microcomputer of the key first compares the limits set in the registers with a real-time clock in the key and an access counter in the key memory. If any of the limits is exceeded, the key will not transmit the key code to the electronic lock and will terminate the operation.

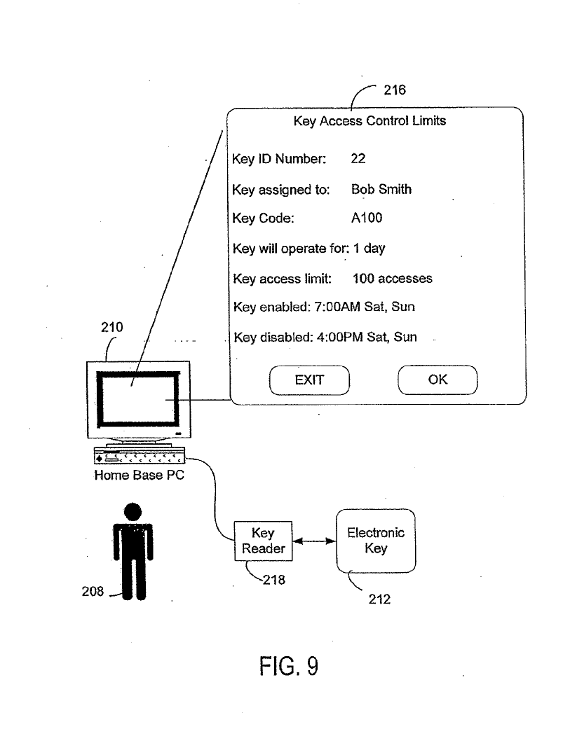

Referring to FIG. 9, the key operation limits may be set by the supervisor 208 of the employee that uses the electronic key 212 to access vending machines in the field. The limits can be selected by using a personal computer (PC) 210 with the appropriate software program. The limits for each key may be customized depending on, for instance, the work schedule or habits of the employee to whom the key is given. For illustration purposes, FIG. 9 shows an exemplary user interface screen 216 for prompting the user 208 to enter the limits. After the limits are selected on the PC 210, they are loaded from the PC into the operation limit registers in the electronic key 212 in a communication process between a key read/write device 218 and the key. During this communication process, other types of data, such as data for updating the real-time clock in the key, may also be loaded into the key. Also, the communication process may be used to transfer data, such as the audit trail data collected from vending machines by the key during previous field operations, from the electronic key 212 to the PC 210.

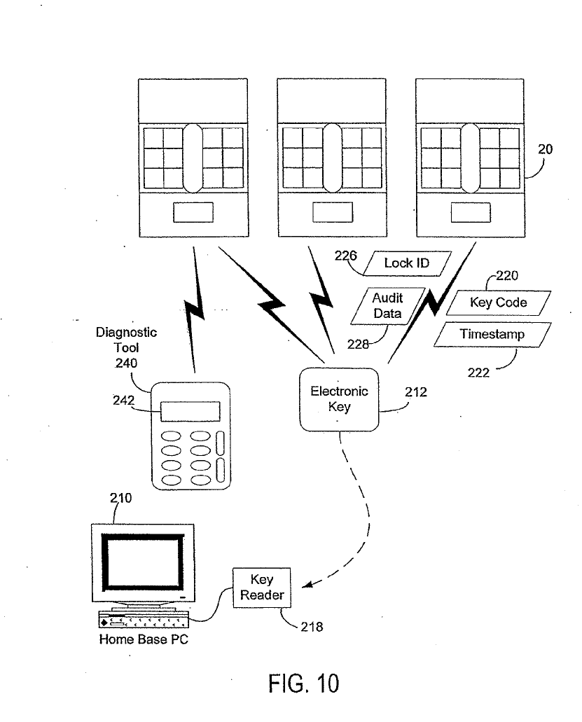

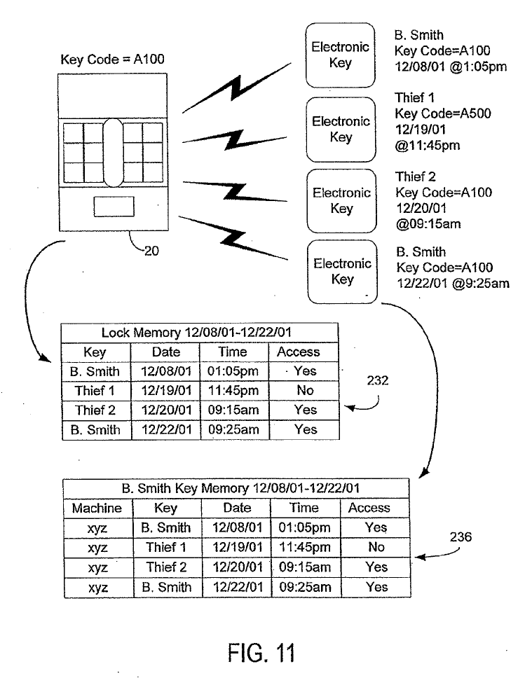

In accordance with an aspect and alternative embodiment, an advantage of electronic keys is that they can be used to record and collect and track the attempted accesses of locks on vending machines in the field. Keys that provide this function are of the “auto-tracking” type mentioned above. Referring to FIG. 10, with an auto-tracking key 212, each access attempt triggers an audit data event in both the electronic key and the electronic lock in the vending machine 20. To that end, a space for audit data is reserved in each of the non-volatile memories of the key 212 and the lock 48. During an access attempt, the key 212 transfers the key code 220 and a timestamp 222 to the lock. Regardless of whether the access attempt succeeds or fails, the lock stores the key code and timestamp in its audit data memory. In one implementation, the lock will filter the number of accesses from a given key in a given period (e.g., one attempt per key for every 20 minutes) so that it does not create a separate record for each access attempt. It may, however, include data in the record counting the number of access attempts from the key in the time period. This minimizes the chances that when a key is used to make many access attempts in a row it will fill the audit trail memory and erase existing records of previous access attempts. One way to set this time period in the lock is to transfer the value of the period from a key (which is in turn set by a supervisor using a PC) to the lock.

If the access attempt results in a key code mismatch or if the key is disallowed for access because an operation limit in its limit registers is reached, the access process is terminates. In either case, the lock transfers its lock ID 228 to the key 212. The key is expected to store the lock ID and the timestamp in its audit data memory as an invalid access attempt.

If, on the other hand, the access attempt results in a valid match of key code and the key has not exceeded its operation limits, the lock still transfers its lock ID to the key 212. The key 212 then stores the lock ID and timestamp in the audit data memory as a record of a proper access. In addition, as the electronic key is an auto-tracking key, the lock transfers all the audit data 228 entries in its audit data memory to the key. The data in the audit data memory includes the lock ID, a record for each access attempt that includes the entire key code (including the key ID digits) received from the key that made the access attempt, and the timestamp for that access attempt. The auto-tracking key 212 then stores the audit data 228 of the lock in its own non-volatile memory. In this regard, each key preferably is capable of uploading the audit data memories of 200-300 vending machines. This eliminates the need for a separate process or equipment in the field for performing the same data retrieving function.

When the electronic keys 212 are returned to the home base, the audit data they generated themselves and the audit data they collected from the vending machines 20 can be transferred to a central control computer 210. The audit data can be downloaded to the PC 210 by the supervisor using the key read/write device 218 that is also used for programming the electronic key.

By way of example, FIG. 11 shows exemplary audit data collected by an auto-tracking key from a vending machine. In this example, the key code stored in the lock on the vending machine is “A100”. The vending machine was accessed using the auto-tracking key on Dec. 8, 2001. Since the key contains the correct key code, the access operation is successful. Thereafter, there were two unauthorized access attempts. The first unauthorized access attempt on Dec. 19, 2001 failed, because the key code (“A500”) in the electronic key did not match the key code in the lock. The second unauthorized attempt on December 20 used a stolen key with the right key code and was successful. When the auto-tracking key is used on Dec. 22, 2001 to unlock the vending machine, the audit data 232 stored in the memory of the electronic lock on that vending machine are transferred to the auto-tracking key, which stores the transferred audit data in its own memory. As stored in the key, the audit data 236 identifies the vending machine from which the audit data are uploaded. The audit data 236 stored in the key are later downloading to the home base PC.

Due to the various complexities of this system concerning multiple key users, key codes, and the multiple keys sharing the same key codes, as well as the flexibility provided by the ease of changing access codes of the vending machines in the field, it is often desirable to provide simple diagnostic capabilities to the keys, electronic locks. It may also be desirable to provide special reader tools for use in the field.

In one implementation, the electronic key uses its LED light to provide several diagnostic signals to the user when its START button is pressed and when it is communicating with the electronic lock. If the key correctly communicates with the lock and the key codes match, the LED light is on continuously for about five seconds. If the key correctly communicates with the lock but the key codes do not match, the LED light flashes around five times a second for about five seconds. If the key cannot establish correct communication with the lock, the LED light is set to flash faster, such as 25 times a second, for about five seconds. If the key correctly communicates with the lock and the key codes match, but the operation limits set in the limit registers are exceeded, the LED flashes at a lower frequency, such as three times per second for about 3 seconds. If the START switch of the key is pressed and the key does not communicate with the lock and its operation limits are exceeded, the LED first flash quickly, such as 25 times per second, for up to 5 seconds, and then flash three time per second for up to three seconds.

In a preferred embodiment, a diagnostic tool 240 is used in the field to communicate with electronic locks on vending machines, which provide diagnostic information in the event of problems with the operation of the lock or the door. As shown in FIG. 10, the diagnostic tool 240 includes a display 242 that displays information read from the electronic lock. For instance, the display may show each of the access control key codes stored in the non-volatile memory of the lock, the lock ID of that lock, and any other information pertaining to the state of the electronic lock, such as an indication of whether the lock expects the door to be in a locked or unlocked state based on a position-control feedback measured by the lock circuit.

In a preferred embodiment, security measures are implemented in the electronic key concerning key tampering by replacing the battery in the key. It is possible that the employees or thieves that gain access to the electronic keys will attempt to trick the security of the system by tampering with the key. Since the key contains the clock that provides the time and date of access limiting, it is likely the users will attempt to disable or trick the clock to override the access limits. For example, if the key operation limits are set to only allow accesses between 7 AM and 6 PM, the user may attempt to disconnect the battery of the key in-between lock accesses to stop the clock in the key from counting down the time and disabling the key.

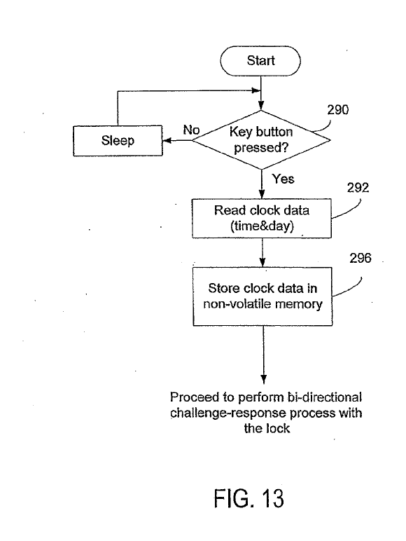

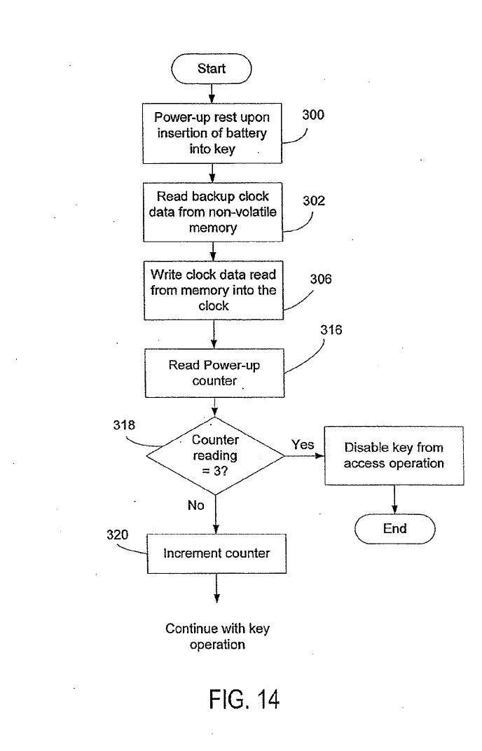

Referring to FIG. 13, to reduce of risk of clock tampering by removing the battery, the key is programmed such that it will reset its clock back to approximately the correct time and date after the battery is reconnected. This feature is provided for both cases of the battery going low naturally or if it is tampered with by the user. To that end, each time the START button 36 of the key is pressed (step 290), the microcomputer 80 of the key reads the time and date from the clock 94 (step 292), and stores the time and date data 298 in the non-volatile memory 82 of the key (step 296). Alternatively, the key may store the time and date periodically, such as every 1-2 minutes. Referring now to FIG. 14, if the key battery is disconnected and later a battery is inserted into the key, the key starts a power-up process (step 300). The microprocessor is programmed to read the back-up time and date 298 stored in the non-volatile memory 82 (step 302) and writes that time and date into the clock 94 (step 306). The clock will then run based on the restored time and date as a substitute until the electronic key is re-docked into the cradle and the home base computer 210 stores a new accurate time and date in the clock of the key. When the restored time and date is in use, the key can still be used to access locks on the vending machines as long as the operation limits of the key are not exceeded.

In addition to the time-restoration feature, the microcomputer 80 in the key employs logic that counts the number of times the battery is removed and will immediately disable the key indefinitely if the battery is disconnected and re-connected more than a pre-selected number of times, such as three times. Specifically, the microprocessor maintains in the non-volatile memory 82 a counter 312 that counts the number of times the key has been powered up since the last docking of the key. This counter 312 is cleared each time the key is docked. Each time a battery is inserted in the key and the microcomputer 80 goes through the power-up process (step 306), the microcomputer 80 reads the counter 302 (step 316). If the microcomputer determines (step 318) that the counter reading has reached the allowed number of power-up, such as 3 times, it disables the key from any access operation. If the allowed number of power-up is not reached, the microcomputer increments the counter (step 320). Thereafter, the key continues with regular key operation, but with each access attempt the key will store a “battery removed” bit with the audit data for that access event in the memories of the lock and the key. This “battery removed” bit indicates that the time and date stamp of the access event is recorded after the key battery was disconnected, and that the accuracy of the time and date is questionable.

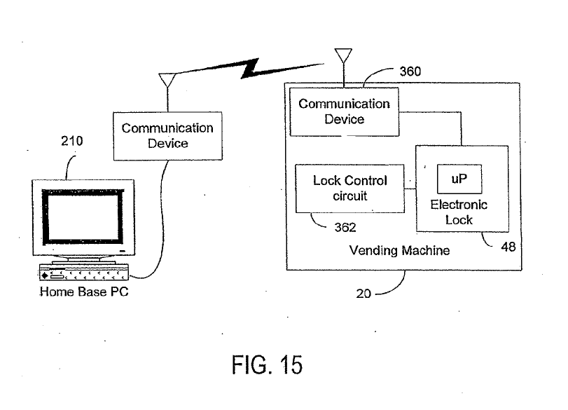

Referring to FIG. 15, in accordance with a feature of an alternative embodiment, the vending machine 20 is equipped with an electronic device for communicating with a home base. The communication device 360 preferably communicates wirelessly, such as over a RF channel, to the computer 210 at the home base of the owner of the vending machine. The vending machine also includes a vendor controller electronic circuit 362 for controlling the operation of the lock 48. The vendor controller 362 is connected to the lock 48 and the communication device 360. The electronic lock 48 working together with the vendor controller 362 and the communication electronic device 360 in communication with the home base can accomplish many of the same access control and auditing functions described above and additionally some inventory and money settlement processes. For example, the communication device 360 can receive a command from the home base to disable operation of the lock 360 regardless if an electronic key with the correct key code attempts to access the vending machine. Also for example, the lock 48 can indicate to home base computer 210 through the communication device 360 which keys have attempted to access of the vending machine. This arrangement eliminates the need to use an electronic key to collect, store, and transfer the audit events to the home base via the memory and communication medium of the key.

Moreover, the communication device 360 may be used with the vendor control 362 to keep track of the inventory and the cash transactions of the machine. In many cases, when the service person (route driver) visits the machine, his job is to fill the machine and collect money. During this task, the vendor control 362 is involved in interfacing with the service person to ensure the proper resetting and settlement processes take place, and that the service person closes the door of the vending machine. The vendor controller 362 can inform the home base computer of the open/close state of the vending machine door. In the case the service person does not satisfy the conditions of the vendor controller 362 by way of inventory or monetary or debit card processing, the vendor controller can send a disable signal to the electronic lock 48 so the door of the vending machine cannot be closed and locked. Thus, since the service person cannot leave a vendor unlocked, this process would force him to complete the required resetting and settlement processes so the vendor controller can allow the vendor door to be locked before the service person leaves the vending machine.

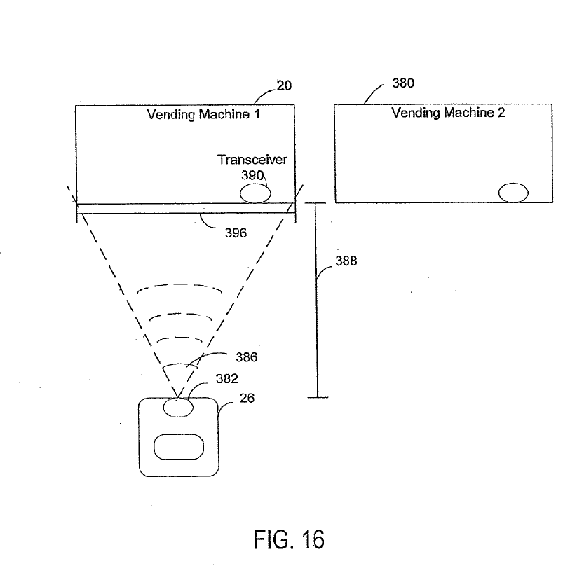

Referring now to FIG. 16, in accordance with a feature of a preferred embodiment, the wireless transceiver of the electronic key 26 is designed to have limited transmission range and angle to prevent a vending machine 380 from being accidentally opened due to receiving stray transmission from the key when the key is used to open another vending machine 20 in its vicinity. Specifically, the transmitter 382 of the key 20 has a pre-defined transmission angle 386. Also, due to the limited transmission power of the transmitter 382, the transmission from the key 26 has a limited transmission power range 388, beyond which the signal strength is generally too weak for the transceiver 390 of the electronic lock of the vending machine 20 to reliably detect.

In a preferred implementation, the transmission power and the transmission angle 386 of the key 26 is selected such that the width 392 of the transmission pattern at the effective transmission range 388 is about the same or smaller than the width of the vending machine 20. As mentioned above, in a preferred implementation, the transceivers in the keys and the electronic locks on vending machines are infrared transmitters for transmitting and receiving infrared signals.

In some of the embodiments described above, the electronic lock in the vending machine is field-programmable by first unlocking the door of the vending machine and actuating a program switch (the LEARN switch 62 in FIG. 3) to set the electronic lock in a programming mode, and then transmitting the new access code and other information from an electronic key to the lock. By requiring the door of the vending machine to be unlocked first, it is ensured that only an operator that has proper access to the vending machine is able to change the access code of the lock. Nevertheless, in certain applications, it may be useful to provide alternative programming schemes that provide similar user-friendliness and security, without the need to physically open the vending machine before the electronic lock can be programmed. Several such alternative programming schemes are described below.

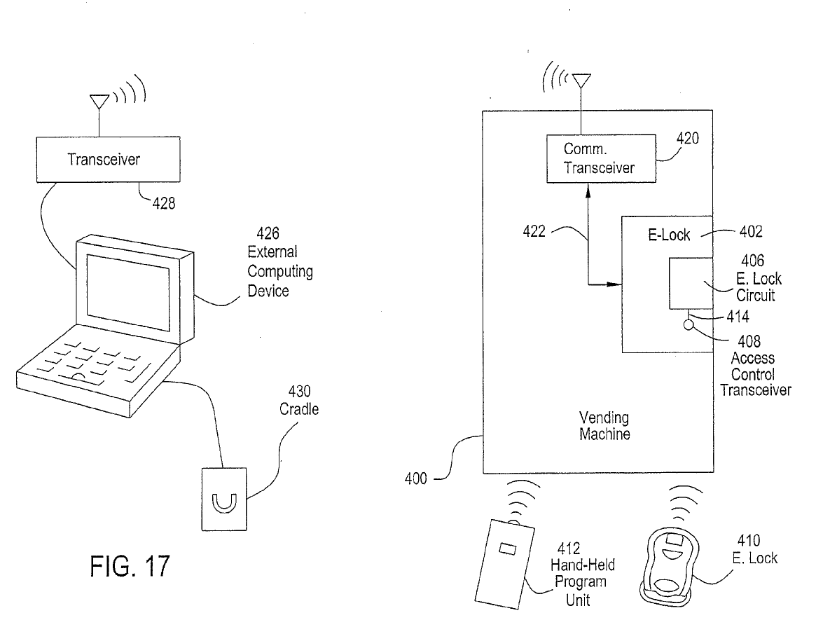

FIG. 17 shows a system in which one or more programming schemes may be implemented for field-programming the electronic lock 402 of the vending machine 400 without having to open the vending machine to access a program switch. Similar to the embodiments described earlier, the vending machine 400 is equipped with an electronic lock 402 with a microprocessor-based lock circuit 406. The lock circuit 406 includes a wireless transceiver 408 for wirelessly communicating with an electronic key 410 and other devices such as a hand-held programming unit 412, as described in greater detail below. The wireless transceiver 408, which is mainly used for access control purposes, is connected to the electronic lock circuit 408 through an access control port 414. The wireless transceiver 408 preferably transmits in a carrier band, such as infrared, that has a short transmission range and a well-controlled transmission pattern.

In addition to the access control transceiver 408, the vending machine 400 further includes a second wireless transceiver 420, referred hereinafter as the “lock communication transceiver.” The lock communication transceiver 420 is connected to the electronic lock circuit 406 through a lock communication port 422. In contrast with the access control transceiver 408, the communication transceiver 420 preferably transmits in a carrier band, such as RF, that has a longer transmission range to enables the lock circuit 406 to communicate wirelessly with an external computing device 426 without requiring the external computing device to be in close proximity with the vending machine. To communicate wirelessly with the electronic lock, the external computing device 426, such as a laptop computer, is equipped with a wireless transceiver 428. By wirelessly communicating with the electronic lock 402 of the vending machine, the external computing device 426 may perform various tasks, including programming the electronic lock circuit 406 and downloading audit data as described below in connection with one embodiment. As illustrated in FIG. 17, the external computing device 426 may further include a cradle 430 for receiving the electronic key 410 or the hand-held programming unit 412.

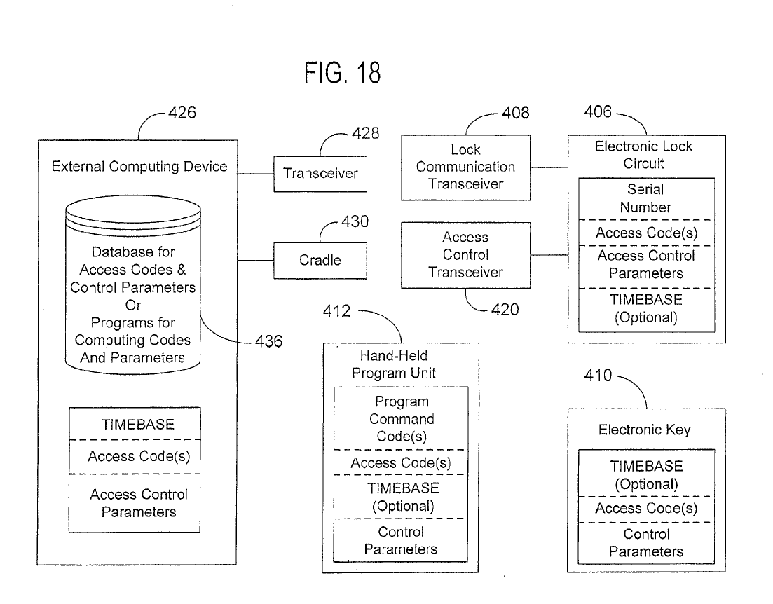

FIG. 18 shows the data stored in the components of the system illustrated in FIG. 17. The electronic lock circuit 406 has a memory that stores the serial number of the lock, one or more access codes, access control parameters, and optionally a digital timebase (i.e., a clock). The electronic key 410 has stored therein access code(s), control parameters for accessing the lock, and an optional timebase. The hand-held program unit (HHPU) 412 contains a program command code, access code or codes for accessing locks on vending machines, an optional timebase, and control parameters. The external computing device 426 has in its memory a timebase, access code or codes for electronic locks on vending machines, and access control parameters for the electronic locks. In addition, the external computing device 426 may have a database 436 containing available access codes and control parameters that can be programmed into electronic locks in vending machines. The database 436 may alternatively or additionally contain programs for computing new access codes and generating control parameters for electronic locks and keys.

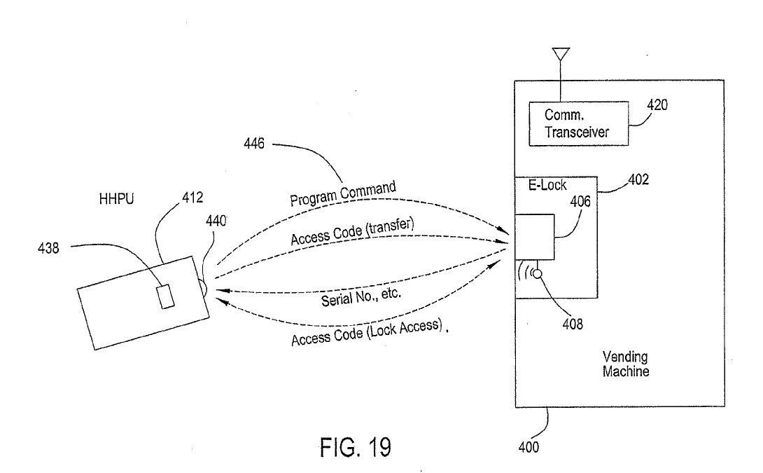

Turning now to FIG. 19, in one embodiment, the programming of the electronic lock 402 of the vending machine 400 is accomplished by using the hand-held program unit 412. The hand-held program unit is intended to be portable so that it can be conveniently carried by an operator to the physical location of the vending machine. As illustrated in FIG. 19, the hand-held program unit 412 preferably has at least one actuation device such as a push button 438. When the transceiver 440 of the hand-held program unit 412 is pointed to the access control transceiver 408 of the lock and the push button 438 is pressed, a command code 446 is transmitted to the lock circuit 406 of the vending machine 400. The command code 446 instructs the lock circuit 406 to enter a receive mode for receiving a new access code. Next, the new access code is transmitted from the hand-held program unit 412 to the lock circuit 406. The lock circuit 406 receives the new access code and stores the code in its non-volatile memory. The transmission of the new access code may be done automatically by the hand-held program unit 412, or may require the operator to push the button 438 or another button designated for triggering the transmission. To ensure the security of the transmissions, the transmissions are preferably encrypted. Moreover, the reprogramming operation may involve a bi-directional challenge-response process similar to the one described above with reference to FIG. 7. The lock circuit 406 may also have the capability of using access control parameters, such as the allowed number of access, time and day of the access, etc., in addition to the access code to control the access of the lock. The access control parameters may optionally be first stored in the hand-held program unit 412 and then transmitted along with the new access code from the program unit to the electronic lock during the programming operation.

As part of the code programming process, the electronic lock circuit 406 may also transmit data such as access codes, its serial number, and/or commands, to the hand-held program unit 412. For example, after receiving the programming command code 446, the lock circuit 406 may send its serial number or current access code to the hand-held program unit 412, which then selects a new access code for transfer to that lock. In addition, the hand-held program unit 412 may also take on the function of an electronic key before or after the access code of the lock has been re-programmed.

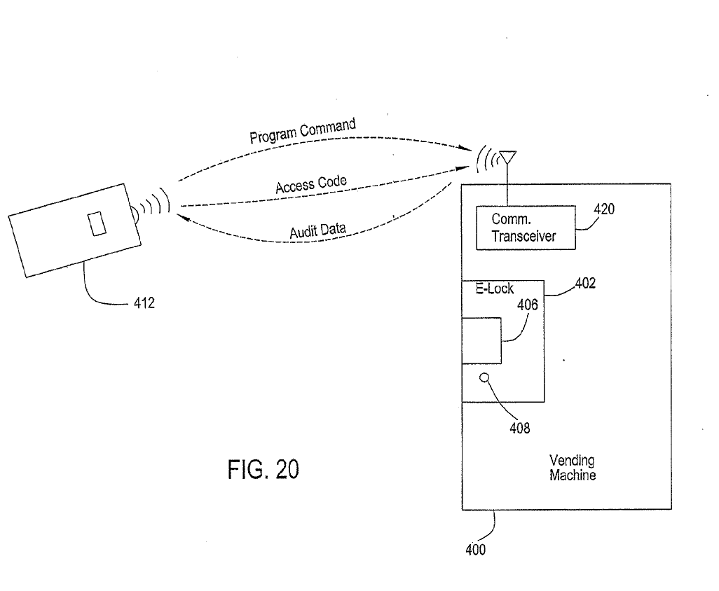

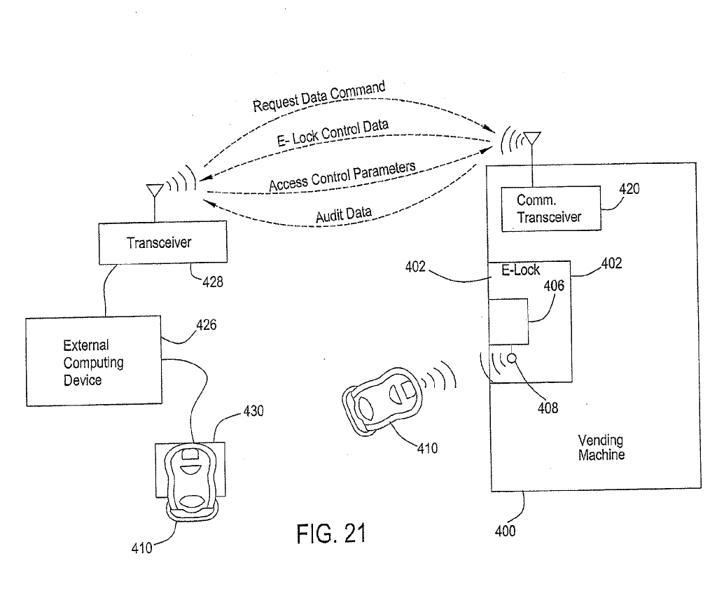

FIG. 20 shows an alternative implementation that is similar to that of FIG. 19 in that it also uses the hand-held program unit 412 to program the electronic lock of the vending machine 400. The difference is that in the implementation of FIG. 20 the hand-held program unit 412 communicates with the lock circuit 406 through the communication transceiver 420 that is separate from the access control transceiver 408 normally used for communicating with an electronic key 410. In this regard, the communication transceiver 420 may transmit data in either an infrared or an RF band.

FIG. 21 shows another embodiment that uses the external computing device 426 to reprogram the electronic lock 402. In one implementation, the external computing device 426 communicates with the electronic lock circuit 406 through the communication transceiver 420 that is separate from the access control transceiver 408. In this programming scheme, the transceiver 420 preferably operates in the RF range to provide a longer communication distance so that the external computing device 426 is not required to be brought very close to the vending machine in order to communicate with the lock circuit 406. Alternatively, however, the transceiver 420 may operate in the infrared band, which may require the external computing device 426 to be in direct sight of the lock for wireless communication. In another alternative implementation, the external computing device 426 may communicate with the lock circuit 406 through the access control transceiver 408, although the effective communication distance will be smaller, requiring the external computing device 426 to be placed closed to the vending machine.

In this embodiment, the lock circuit 406 preferably has the capability of using access control parameters to control the access of the lock. For example, the access control parameters described above, such as the allowed number of access, time and day of the access, access code, etc., may be stored and used by the lock circuit. To program the lock circuit 406 with a new access code and/or new control parameters, the external computing device 426 first polls the electronic lock circuit 406 of the vending machine by sending a Request Data command. The Request Data command also servers as a program command telling the microprocessor of the lock circuit 406 to enter a program mode. During the polling process, the external computing device 426 issues commands to request the lock circuit 406 to transmit data such as the serial number of the lock, access codes, and/or the audit data of the lock. The lock circuit 406 responds by transmitting at least the data requested by the external computing device 426. After receiving the requested data from the lock, the external computing device 426 may generate a new access code for the lock and/or other information pertaining to accessing the lock, such as encryption codes, time parameters, access control limits, etc. To that end, the external computing device may have a database 436 that contains appropriate access codes and control parameters that have been calculated previously for electronic locks, electronic keys, or both. Alternatively or additionally, the external computing device 426 may also have programs that implements mathematical algorithms for computing the access codes and control parameters. Such calculations may generate the access codes randomly or based on a function that includes the time as a variable. The external computing device 426 then wirelessly transmits the new access code and/or control parameters to the electronic lock circuit 406 via the wireless communication link between the transceiver 428 and the communication transceiver 420. To protect the transmissions from eavesdropping, the transmissions are preferably encrypted. Also, the reprogramming operation may involve a bi-directional challenge-response process similar to the one described above with reference to FIG. 7.

After receiving the new access control data from the external computing device 426, the electronic lock circuit 406 recalibrates the lock control functions based on the received data. For example, after receiving the access code or codes and parameters, the lock circuit 406 may change the access codes and access limits based on the received access control parameters. In this way, the electronic lock is reprogrammed by the external computing device 426. Next, the external computing device 426 may optionally be used to program an electronic key 410 that can be used to visit and access the vending machine 400 through the access control transceiver 408. To that end, the electronic key 410 is connected to the cradle 430, and the access code that has been programmed into the lock is transmitted via the cradle into the key, together with any other appropriate access control parameters for the key. The key 410 can then be used to access the vending machine by communicating with the electronic lock circuit 406 via the access control transceiver 406 based on the newly programmed access code(s) and control parameters.

By way of example, in the context of servicing vending machines, an operator may drive to the building in which the vending machine is located. In his service vehicle, the operator uses a laptop computer that functions as the external computer device to wirelessly communicate with the electronic lock of the vending machine by sending RF signals. By means of the RF communications, the laptop programs the lock of the vending machine with a new access code and control parameters. For instance, the new access code may be given an active period of 15 minutes, and the operator has to access the vending machine within that time period. The operator also uses the laptop to program the same new access code into an electronic key. The operator then walks up to the vending machine and uses that electronic key to communicate with the lock circuit via the access control infrared transceiver to open the door of the vending machine. In this scenario, the lock of the vending machine and the associated key are programmed “on the spot.” After the operator has accessed the vending machine, the access code programmed into the electronic lock may simply go expired. In other words, the lock of the vending machine may not have any valid access code until it is reprogrammed next time by the external computing device.

In an alternative implementation, the same process of programming the lock with an external computing device and then accessing the lock with an electronic key is utilized. In this programming scheme, however, the access information transferred to the electronic lock circuit 406 is based on access code(s), access limit parameters, etc. that are already in the electronic key 410. In other words, the external computing device 426 does not generate the access control information, but instead takes the information from the electronic key. The electronic key, for example, may contain the access codes and access limits for the lock for that day. To reprogram the electronic lock, the electronic key 410 is placed in the cradle 430, and the external computing device 426 reads the access control information from the key and transmits the information to the electronic lock circuit 406 via the communication transceiver 420. After the electronic lock is programmed with the new access code and other control parameters, the operator takes the key 410 to the location of the vending machine and uses the key to access the lock by communicating with the lock via the access control transceiver 408 based on the new access code and/or operation parameters programmed into the lock.

Before or after the electronic key 410 is used to access the electronic lock, the lock circuit 406 may also send audit data for both successful and unsuccessful access attempts to the external computing device 426 via the communication transceiver 420. Alternatively, the audit trail data may be downloaded from the lock circuit 406 into the electronic key 410 when the key is used to access the electronic lock.

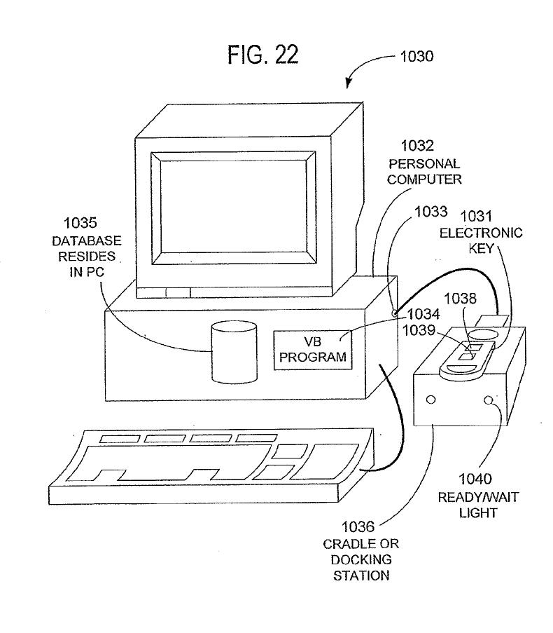

To set the access control parameters for electronic keys and to manage the audit data collected by the electronic keys from the vending machines, an electronic key management system (or station) 1030 is provided in an embodiment shown in FIG. 22. The key management system 1030 includes a computer 1032 which may be a desktop personal computer (PC), with appropriate computer software and hardware for carrying out the functionality of key management and database operations. The software program 1034 for key management and database operations may be a Visual Basic program executing on the PC. The computer 1032 also includes a database for storing data for key management and audit data collected from vending machines. As used herein, “database” may include data files as well as a database program. In one implementation, the database 1035 may be a Microsoft ACCESS database residing on the PC 1032.

As illustrated in FIG. 22, the electronic key 1031 includes a status indicating device which may be an LED light 1038, and a push button 1039 that when pressed causes the key to start wireless transmission. To communicate with the electronic key, the key management system 1030 includes an interface device for forwarding and receiving communications to and from an electronic key. In the embodiment illustrated in FIG. 22, the interface device is in the form of a cradle 1036 (or docking station) that interfaces the key to a communication port 1033 on the PC 32. The cradle 1036 has a receiving place for receiving the electronic key, and indicators such as a ready/wait light 1040.

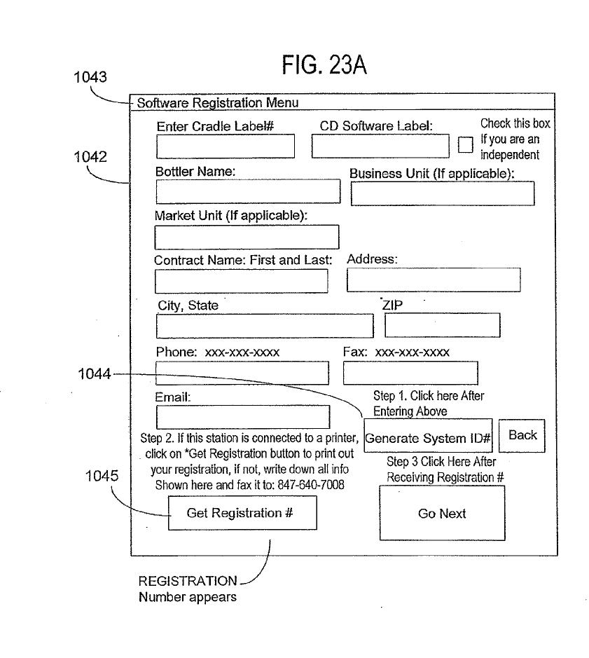

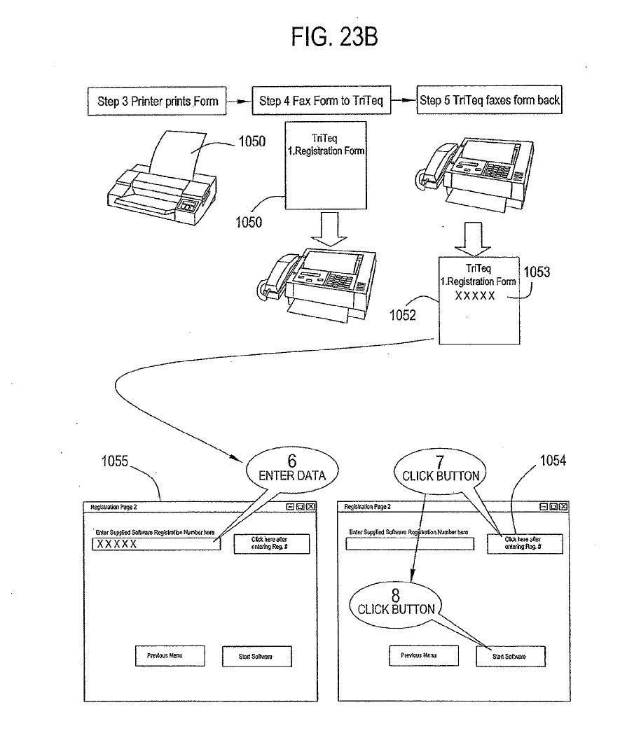

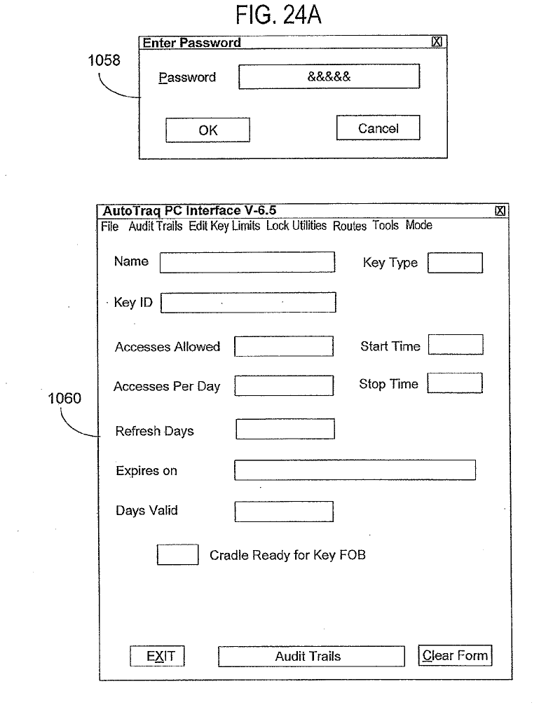

In accordance with a feature of the embodiment, the database 1035, software 1034 and cradle 1036 transceiver interface systems are limited for secure operation on only one particular computer 1032 by means of registration. The software programs and the cradle can properly function only after they are registered with an authorized control center. Thus, a thief cannot install stolen components on a computer at an unauthorized location. The steps of an exemplary registration process are described with reference to FIGS. 23A and 23B. FIG. 23A shows an interface screen that presents a registration form 1042 and a Software Registration Menu. After the software programs are installed on the computer 1032, a user may click on a “registration” tab in the menu bar to bring up this registration form. To fill in the required data, the user looks at the bottom of the cradle 1036 for the cradle serial number, and enters this number into the form 1042. The user looks at the compact disc (CD) containing the key management software for the CD serial number, and enters it into the form. The user also fills in other required information, such as contact information including the bottler name, contract name, address, phone number, etc., into the registration form. Once the registration form 42 is properly filled, the user clicks on the “Generate System ID#” button 1044. After this button is pushed, the software program generates a system ID number for this system based on the serial numbers and/or other information entered by the user. The system ID number appears at the bottom of the form 1042 under the “Get Registration #) button 1045. The user then clicks on the “Get Registration #” button. In response, the software program generates a registration form containing the user-entered information and the system ID number, and sends the form to the printer for printing, as illustrated in FIG. 23B. This registration form 1050 is then sent, for example via facsimile, to the control center (e.g., TriTeq Corporation) so that the control center can register the key management system using the system ID number. The control center then issues a special code 1053 as a registration number for the user's system. The special code is generated based on the system ID number and possibly other information provided by the registration form 1050. This registration number 1053 may be sent to the user in a registration response form 1052 that may be transmitted via facsimile to the user. The registration number may also be sent via other means of communication, such as email, mail, or voice communication (e.g., a phone call). The user then goes to the next screen 1055 of the user interface for software registration, and enters the received code 1053 into a provided field. After the user clicks an Enter button 1054, the software stores the entered registration number in a special memory location.

The registration process described above links together the serial numbers assigned to and/or embedded in the software 1034, the interface cradle station 1036, and the computer 1032 to create an authorization number stored in the database 35. Each time the software 1034 is restarted, it reads the serial numbers of each of the components to calculate the authorization number, and then compares this number to the authorization number in the database to make sure they match before operating. If the calculated authorization number does not match the stored authorization number, the software does not allow the user to access the system management functions, and the system is inoperative.

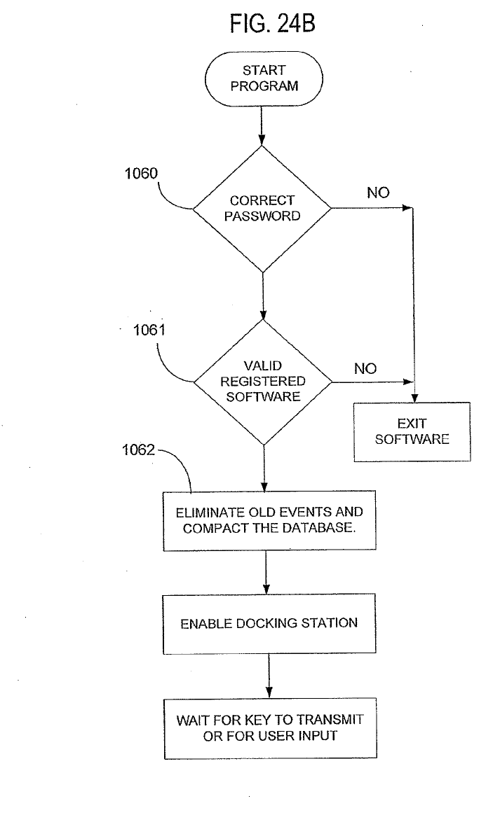

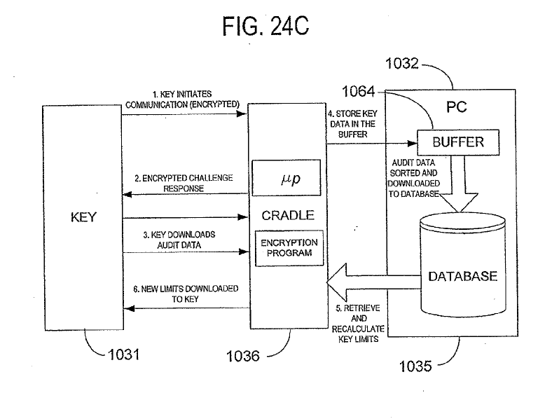

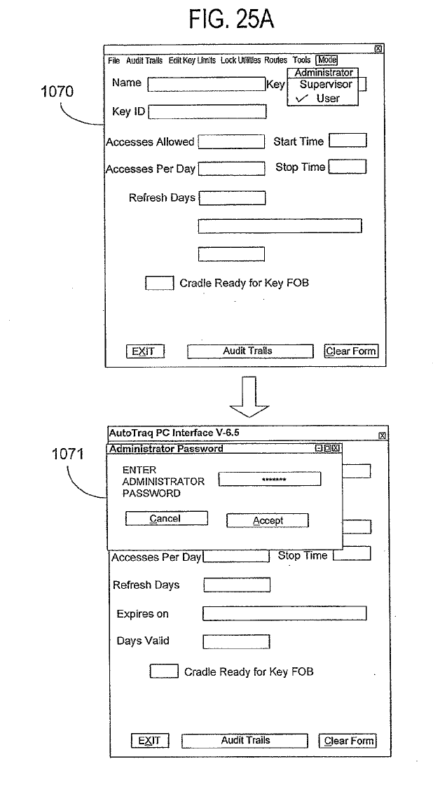

FIGS. 24A & 24B describe how the database interaction with the docking station or cradle is initiated by starting the software system which allows database accesses and data transfer to/from the database. One password is optionally required to initiate the “User” operation mode. As shown in FIG. 24A, after the software is started, the software presents a window 1058 on the computer screen for the entering of a password. The software then presents a key control window 1060 that contains various control parameters or limits for controlling the operations of the electronic key. For instance, the key control screen in FIG. 24A includes fields for the name of the user of the key, the ID number for the electronic key, the key type, the total number of accesses allowed, the allowed number of accesses per day, the start and end times of the operative period of the day, the expiration day and time, and the number of days in which the key is valid, etc.

Referring to FIG. 24B, when the software program 1034 is started, the software presents the password window as shown in FIG. 24A and waits to receive a user mode password. When a password is received, the program determines whether the password is correct (step 1060). If the user password is incorrect, the software program exits from operation. If the user password is correct, the program determines whether the system is properly registered in the way described above. If the system is registered, the program works on the database 1034 by eliminating old events and compacting the database (step 1062). The program then turns on the cradle 1036, and waits for transmissions from an electronic key docked in the cradle.

Turning now to FIG. 24C, to initiate a docking or refresh operation of the key 1031, the key is placed within communication distance of the cradle 1036. As shown in FIG. 1, the cradle 36 may have a receiving location on its top into which the key may be placed. The user then presses the transmit button 1039 of the key 1031 to cause the key to start transmission. The transmission from the key is received by the cradle 1036 and forwarded to the computer 1032. Likewise, communications from the computer 1032 are sent to the cradle 1036, which then transmits the communications to the key 1031. FIG. 24C illustrates that first the key 1031 and cradle 1036 exchange encryption messages to ensure that an authorized key is communicating with the station. To that end, the cradle 1036 includes a microprocessor for providing the processing power and has software programs including an encryption program for handling the encryption/decryption involved in the challenge-response communications and any subsequent communications. Next, if the key contains access audit data collected from vending machines in the field, the data is downloaded from the key and stored in a buffer 1064. The data in the buffer 1064 may then be sorted and loaded into the database 1035. The new operation limits (see FIG. 24A) pre-set by a supervisor for that electronic key are then downloaded into the key 1031.

In accordance with a feature of the embodiment, the operation of refreshing the key and downloading data from the key is automatic, without requiring a user to oversee or activate each of the steps involved in the process. All the user has to do to initiate the key refreshing operation is to place the key 1031 in the cradle 1036 and press the transmit button 1039 of the key, and the software program 1034 will finish the operation without requiring further attention from the user or system administrator. During this process the database 1035 proceeds to service the key without prompting the user to enter any information or data at the computer either before or after the key is initiated. As a result, the key refreshing operation may run in the background, without the need to have an open window on the computer screen, thereby allowing the computer 1032 to be used for other operations such as word processing or communications over the Internet. To service the next key, the previous key is removed, the new key is inserted and its transmit button is pressed. Again, the database proceeds to service the key without prompting the user to enter any information or data at the computer either before or after the key is initiated. The docking or refresh operation can be performed without the supervisors present, which allows the system to perform without daily maintenance.

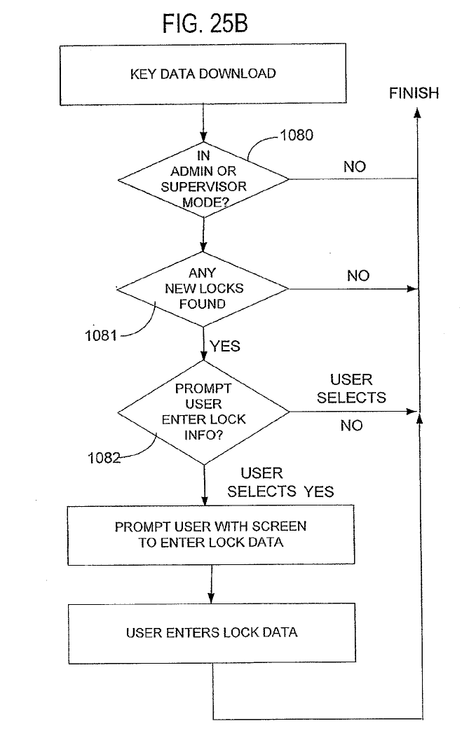

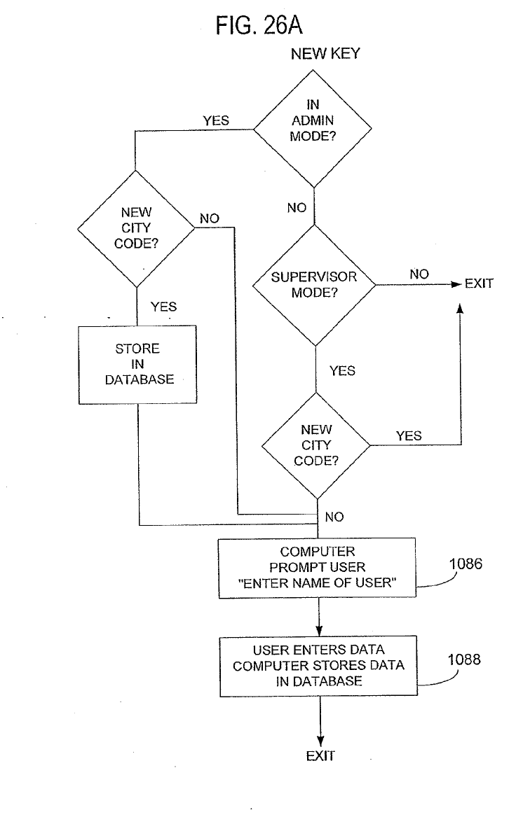

FIGS. 25A & 25B illustrates an advanced set-up feature of an embodiment of the key management system that is only accessible by entering a secure operating mode, which may be either the “Supervisor” or “Administrator” modes. As shown in FIG. 25A, the software first presents a key control window 70 similar to that in FIG. 24A. By clicking on the Mode option in the Menu bar, a user can select to run the software in a Supervisor mode or a User mode. Selecting the Supervisor mode causes the software to open a password entry window for either the administrator or supervisor. The user then enters the password as an administrator or supervisor into the field provided. In one implementation, an administrator oversees multiple supervisors, while each supervisor supervises multiple users to which electronic keys are assigned. When a user signs in as the administrator, he can use the software to add or remove supervisors from the key management system as well as administrating the functions of the key management system. A supervisor can use the software to add or remove electronic keys and/or key users, and set or change key limit parameters.

As shown in FIG. 25B, when audit data is downloaded from an electronic key, the software program determines whether it is in the administrator mode or supervisor mode (step 1080). If neither, the program finishes the key refreshing operation by loading new key parameters into the key. If the program is in the administrator or supervisor mode, the program checks the audit data received from the key to see whether the data contains identifications of any vending machine electronic lock that is not found in the database (step 1081). In this regard, the audit data stored in an electronic key are collected from electronic locks in vending machines accessed using the electronic key. The audit data collected from an electronic lock contains, among other things, a serial number of the electronic lock. It is possible for the electronic lock of a vending machine to be programmed in the field to work with a given key before the ID number of the lock is registered in the database of the key management system. If the key management program finds a new lock serial number in the audit data downloaded from an electronic key, it prompts the user to enter the lock information into the database (step 1082). If the user selects not to do so at that time, the program continues the key refreshing operation. If the user selects to enter the lock information, the program present a user interface window (step 1083) to allow the user to enter information about the electronic lock (step 1084). The program then continues to finish the key refreshing operation.

In accordance with an aspect of the embodiment, the electronic keys contain certain key codes for access authorization purposes. It is desirable to limit which keys can be serviced by which computers such that stolen or lost keys cannot be serviced at computers they are not authorized to be serviced at. Thus, the database preferably contains a feature to limit which serial number sequence keys it will service and which it will not service. If a key is not in this serial number range, the database, computer, and software will refuse to service it. The limit parameters are usually entered into the database by a supervisor just after installing the software.

Key Set-Up

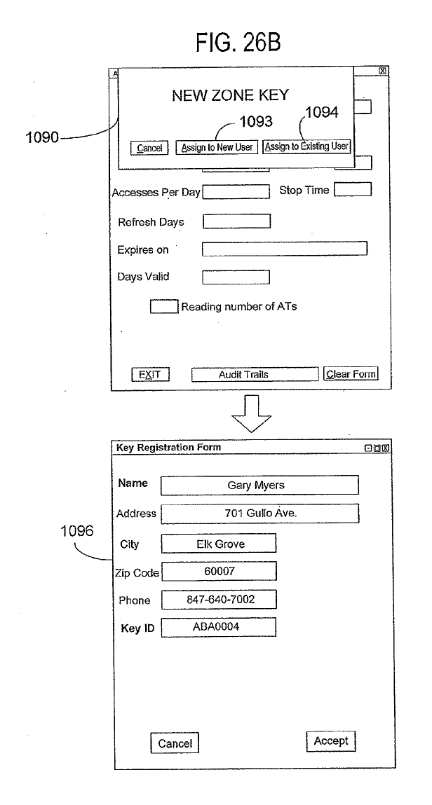

Certain set-up procedures are implemented in the system in order to make the security features of the system useful and easy to use. FIGS. 26A & 26B illustrate these features. First, the electronic keys need to be assigned to the employees. This is accomplished by a simple operation, as shown in FIGS. 26A and 26B. First, a new key never previously initialized (or not contained in the database) is placed within communication distance of the cradle station interface and the transmit button of the key is pressed. Next, the supervisor is prompted to enter the name or identifier of the user to which the key is to be assigned (step 1086). The supervisor enters the required data, and the data is stored in the database (step 1088). If it is for a new key user, the process is described in FIG. 26B. The software recognizes automatically that a new key is introduced into the system. In one implementation, the key indicator light stays “ON” and the cradle light stays “RED” when it is communicating with the key. Afterward, the program provides the user interface screen 1090 shown in FIG. 26B to prompt the supervisor or administrator to assign the key to either a new user or an existing user. If the supervisor presses the “Assign New User” button 1093, the screen 1096 appears for the supervisor to enter information regarding the new user who is going to use the key. After entering the information, the supervisor clicks on the “Accept” button, and the new user information is stored in the database 1035. Next, the transmit button 1039 of the key is pressed again, and the program presents the key control window to allow the supervisor to set the limits for the key operation. When the user enters this name, the database links the serial number embedded in the non-volatile memory of key with the name for reference purposes. Also, a set of default limits are assigned to the key in the database, such as 200 total accesses, 20 access per day, 6 AM to 6 PM operation, 7 days of operation, Monday through Friday operation. FIG. 26A also illustrates how only the supervisory or administrator sets the database up to allow the territory code to communicate to the database.

In managing the keys in an on-going basis, the supervisor may use the system to check the limit parameter status of the keys to quickly see which keys are either expired or approaching the end of their operation limit parameters. This is accomplished for example by selecting the “Edit Key Limit” menu on the main screen of FIG. 25A. In response, the program displays a list of the registered electronic keys and for each key the expected time and date the key will exceed its limits in a row and column format for viewing by the user.

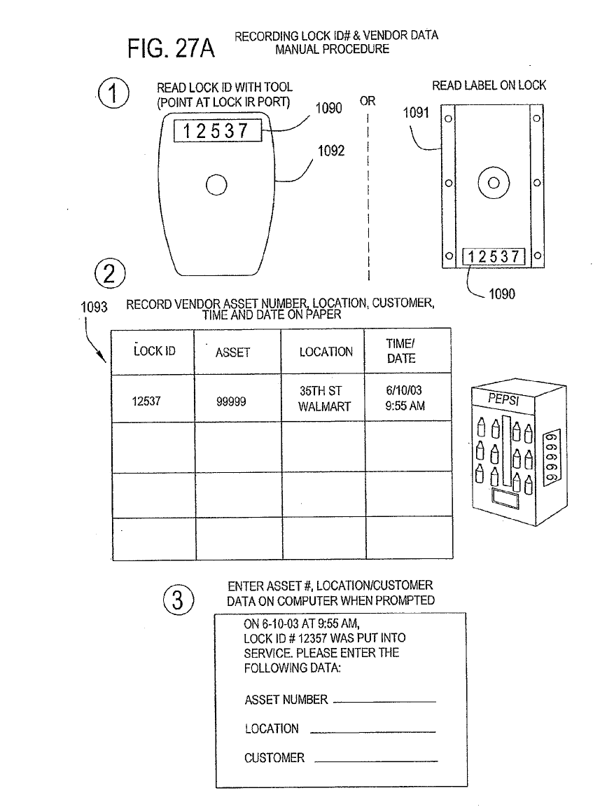

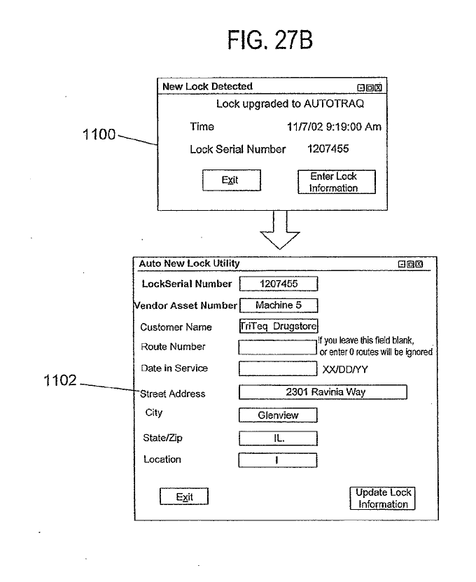

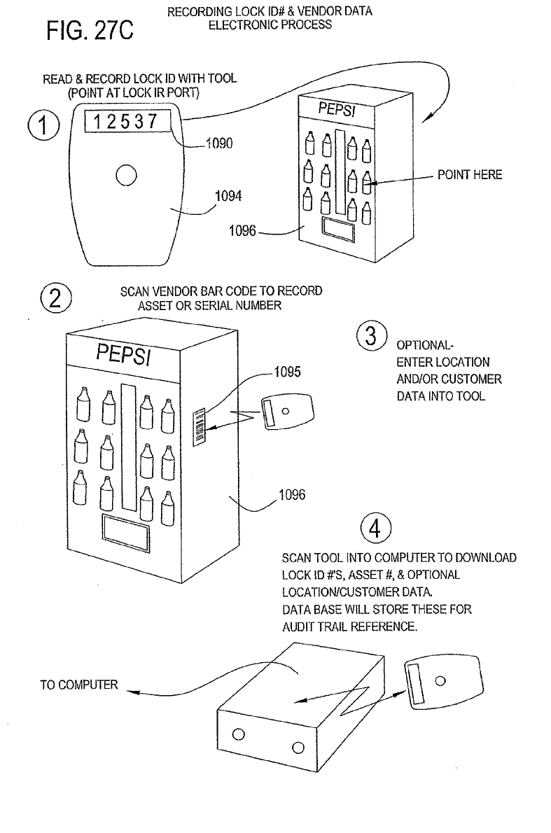

Next, the electronic locks to be accessed with the keys need to be assigned to Customers, locations, and/or asset identifier numbers (identification data). FIGS. 27A-27C illustrate two methods. This procedure is necessary because the lock is initially identified by the database using a lock serial number embedded inside the lock non-volatile memory that is not easy or obvious for the user of the system to reference or identify to. Once each lock is referenced to a number or name that the user can more easily identify with, understanding and using the audit trail data will be more likely. There are several possible procedures for entering the lock information. Each procedure is possible even if the lock is remotely located from the computer and either cannot or does not directly transfer its serial number to the computer and database.

In one procedure shown in FIG. 27A, the lock serial number 1090 is printed on a label 1091 attached to the lock as an alphanumeric number or as a barcode or other identifier. This number can be visually read and recorded in a form 1093 along with the customer, location, and/or asset identifier number for the lock, and then manually entered into the database 1035. The disadvantage of this system is if the serial number label is lost or not legible, it would be difficult to identify the electronic lock.

In another procedure also shown in FIG. 27A, the lock serial number 1090 is not printed on a label, but is read from the lock by a diagnostic tool 1092 to make certain the correct serial number is recorded. This number can be visually read from the tool display, recorded along with the customer, location, and/or asset identifier number, and manually entered into the database. In this procedure, a lost label on the lock will not impede the process.

FIG. 27B describes the manual entry process of entering the collected lock, vending machine, and location information and entering it into the database. In the shown example, a key assigned to a user “Gary Myers” has visited a new vending machine that are not registered in the database 1035. The electronic lock information is time-stamped into the key when the key is used to access the lock. When the key user returns to the key management system 1030 and places the electronic key into the cradle 1036 for key refreshing operation, the lock information is downloaded from the key to the computer. The program notices that the downloaded key data contains new lock information not already entered into the database. For each new electronic lock identified in the key data, the program presents a “New Lock Detected” window 1100 on the computer screen showing the lock serial number and the time at which the lock was accessed. When the user clicks the “Enter Lock Information” button, the program presents a “New Lock Data” screen window 1102 to allow the user to enter detailed information about the vending machine containing that electronic lock, such as the vending machine asset number, customer number, route number, date in service, and location address, etc. After entering the information, the user clicks the “Update Lock Information” button, and the information is stored into the database. The program than presents another “New Lock Data” screen for the next new lock identified in the downloaded key data.

In another procedure shown in FIG. 27C, the user has an electronic tool 1094 that electronically reads or scans the serial number 1090 from the electronic lock (either by communicating with the lock or reading the printed label) and electronically reads or scans an identifier label 1095 on the vending machine 1096. This electronic reader or scanning device links the two identifier numbers together in memory. This procedure can be repeated for many vending machines for as long as the reader does not run out of memory. After the scan/read process is completed, the reader 1094 can download its data into a computer that can ultimately transfer this data to the database. In this procedure, the lock and vending machine data is electronically linked, so the manual data entry procedure can be avoided.

Lock-Database Data Exchange

In accordance with an aspect of the embodiment, data may be exchanged to/from electronic locks of vending machines and the key management database 1035. One method involves using an electronic key to collect the audit information in the lock and ultimately transfer this data to the database 1035. In alternative embodiments, wireless communications may be used for the data transfer. For example, the lock can communicate directly (or indirectly) through a wireless medium to a computer transceiver interface to transfer the data to/from the database. The preferred embodiment described below uses the electronic keys to transfer the access limits and the audit trail information, but this embodiment is not limited to this method.

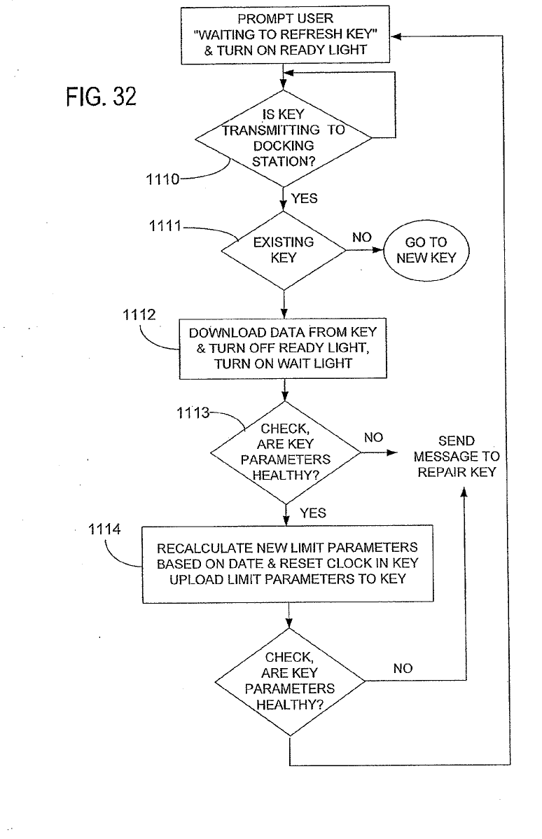

During service of the key 1031, data is exchanged from the key to the computer 1032 and from the computer to the key as described in FIG. 32. Before this exchange takes place, the cradle 1036 is in the receive mode, wherein any transmission signal from the key will initiate the data exchange process. The timing and sequence of the data exchange is automatic, and it is only necessary to initiate one start operation at the key to exchange the data in both directions. The communication between the key and the cradle is preferably protected by bi-directional encryption methods. During the process, the program determines whether the key is transmitting to the cradle (step 1110). If the key transmission is received, the program determines whether the key is an existing key or new key (step 1111). If the key is an existing key, the data stored in the key is downloaded from the key (step 1112). The program then checks whether the key parameters are healthy (step 1113). If so, the program retrieves or recalculate new limit parameters for the key, reset the clock in the key, and upload the limit parameters into the key (step 1114). The computer will proceed to service the key provided it is authorized to do so. Such authorization may be provided in the database locally stored on the computer hard drive. One can have such authorization at multiple computers if the authority is granted.

In the event of multiple computers authorized to service the same keys, rather than having multiple computers with multiple databases local to the respective computers, it may be more convenient to have one database residing on a central server or shared drive so more than one computer and cradle can be used to service the keys. Thus, the authority to service the key resides in one database and all of the data exchanged is managed in one database rather than multiple databases. In that case, the data exchanged from the key to the computer may be immediately transported to the database or stored locally at the computer and later processed by the computer and loaded in the remotely located database. This may be a more desirable process since the data transfer may be very time consuming during heavy traffic hours on the network and may better and more reliably be transferred during low traffic times.

During this data exchange process, the health of the electronic key can be diagnosed. For example, the clock in the electronic key is read by the computer and compared to the clock in the computer. If there is a mismatch in time, the computer can alert the supervisor that the key can a faulty clock or battery. Likewise with the memory in the key. If the data exchange process is not successful, the battery or the memory may be suspect to be faulty, and the computer will display this fault for the user or the supervisor so the battery can be replaced or the key taken out of service.

Audit Data

During service of the key, the vending machine audit data collected by the key is downloaded from the key to the cradle 1036, next to the computer memory buffer 1064, and last to the database 1035 of the computer. The data is managed by the supervisor by allowing each lock serial number to be identified in the database by the customer, location, and/or asset identifier number as previously described is set-up. The software may allow several options for managing this data in the database. This process is executed only one time for identifying the asset number, and one time for each time the vending machine is assigned to a customer or a location. The processes for identifying this data are as follows:

Pop-Up Request Process

FIG. 27B illustrates this process. In this process, the software will run a test while in the supervisor mode that will search the lock serial number in the data base. If no such number is identified, the software will prompt the supervisor to enter the data. The software will provide as much information about the vending machine as possible to help for the identification, such as the time and data the lock was first put into service or accessed.

Manual Process

The software will provide a menu to select the identification process. Next, a drop down list will list in numerical order all lock serial numbers that are not identified. Next, the user will select the lock that he/she wishes to identify. After selected, a screen is provided to enter the data. Also provided is a field for entering the effective data in case the identification data is entered several days or weeks after the data the data is valid.

This process can also be executed when viewing audit events from the database. In this situation, the lock serial number is displayed to identify the vending machine (in lieu of the vending machine asset number, customer, and location data). By selecting this number from this display position and clicking, the screen to enter the vending machine data will pop-up for ease of data entry.

FIG. 27B also illustrates that this process is also used after a lock is identified but the user wishes to change or modify some of the data, such as changing the customer information or location if a vending machine is moved or relocated. In this situation, the effective date field is used to properly record the exact date the change took place in case the data entry follows the change by a delay period.

Automatic process. It is possible for the identification data to be transferred automatically into the lock database. This identification data will be entered separately from another computer and/or database which separately contains the vending machine identification data.

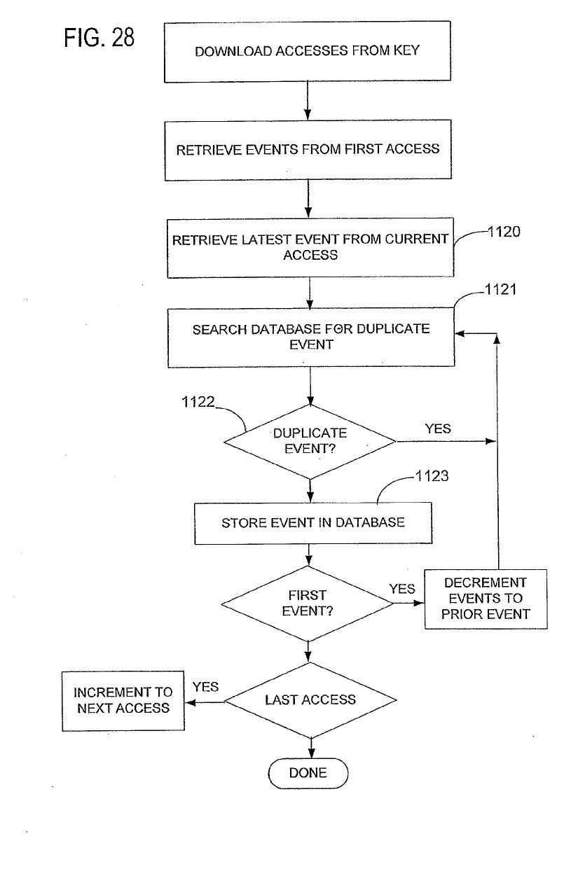

Referring now to FIG. 28, as audit data is received from the key it is compared to previous data in the database. Since one or more key may bring duplicate access audit data back to the same database, it is necessary to compare the new data received from the keys with the data presently in the database and discard the like data so duplicate access data is not stored. To that end, when the program receives data downloaded from the key regarding an access attempt event (step 1120), it searches the database for any event that is duplicate to the downloaded event (step 1121). If a duplicate event is found in the database (step 1122), the downloaded event is discarded. Otherwise, the event is stored into the database (step 1123), and the program moves to the next event described in the downloaded data.

If access data is determined to be new, it is stored in the database 35. Suitable data sorting techniques are preferably used in order to efficiently store this data, and to efficiently retrieve this data in the future, and in the future compare this data to new data collected. The software shall be configured such that the audit information in the database cannot be modified or deleted, either accidentally or on purpose, in order to preserve the integrity of the security monitoring system. After audit data is stored in the database, certain data sorting techniques are required to make the viewing of the data useful.

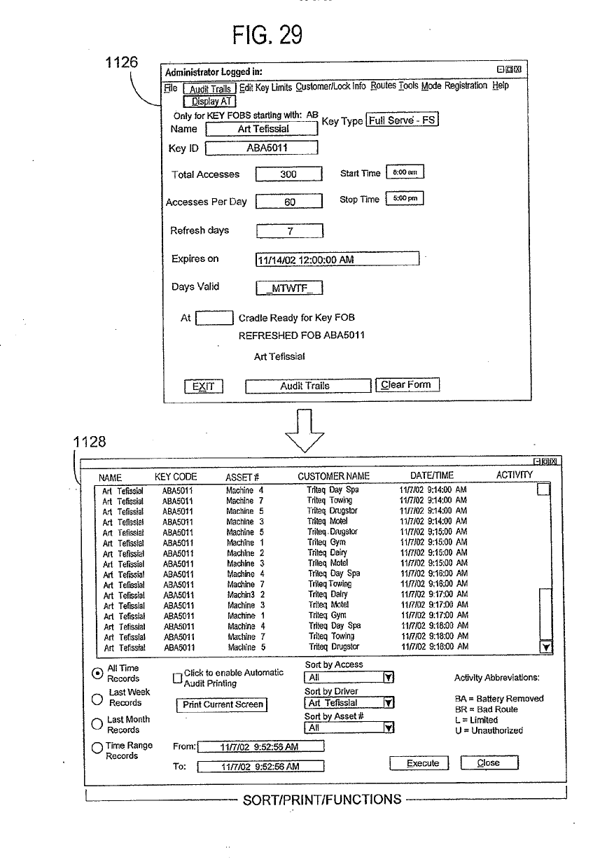

For example, FIG. 29 illustrates it is possible to sort and view the data by Access, by Driver or Employee, by Asset number, or between certain time and date periods. Each of these sort parameters can be combined to sort multiple combinations of parameters. Also, as the audit information is displayed, unusual activity that occurred before or during the access event can be displayed, such as Battery Removed (from the key), Bad Route, Limited, and Unauthorized. To view the audit trails data, the user either clicks the “Audio Trails” button at the bottom of the Key Control Data screen 1126 or use the task bar menu. This function is only available to supervisors and administrators. The program then displays the audit trails screen 1128. The bottom portion of the screen 1128 presents sorting options that allow the data to be sorted in various ways, such as by time, access, key user, or asset number, etc. Different combinations of these options may be used to refine a search.

The audit trails data may also be printed. In one implementation, the printing options available are “Automatic Audit Printing” and “Print Current Screen.” Automatic printing allows for printing when a key refresh is executed and prints all the new events the key has encountered. The audit screen does not have to be displayed on the computer screen to enable printing.

Limiting Operational Parameters for Keys

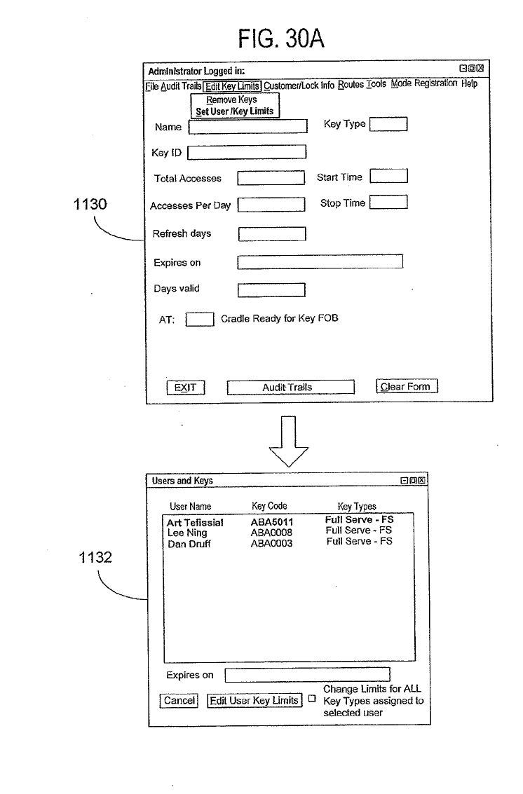

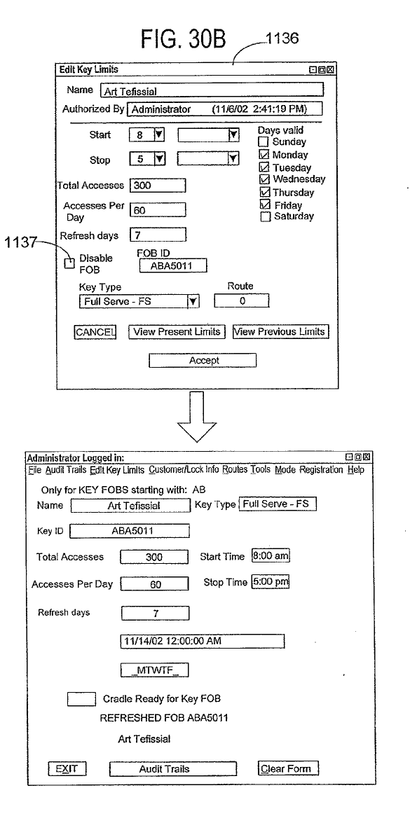

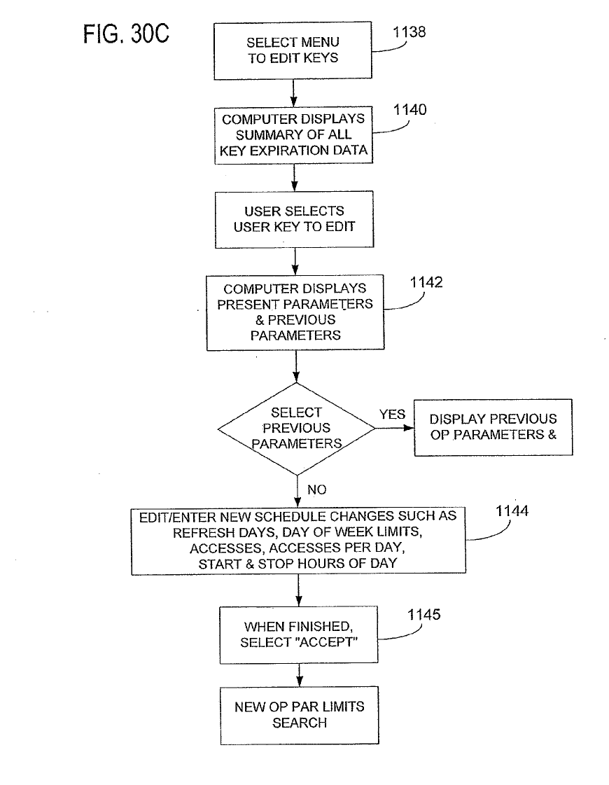

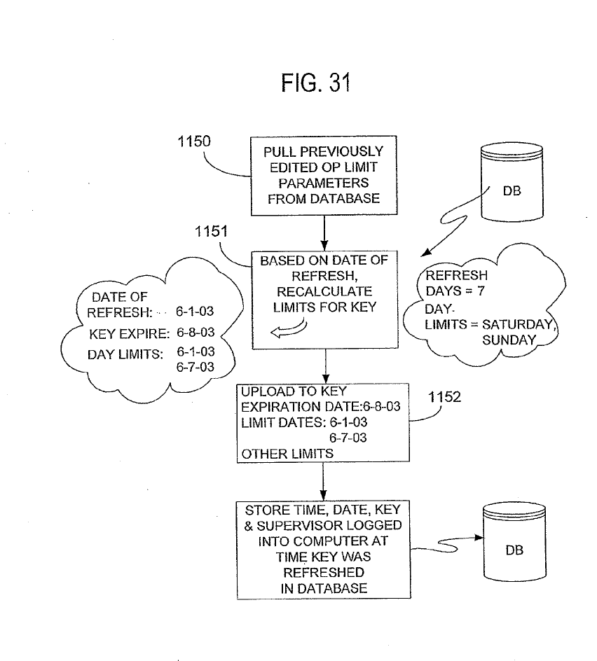

Limiting operational parameters are available for keys. To ensure the security of the system, in a preferred embodiment such new limits can be assigned only when the computer is in the Supervisor or Administrator modes. FIGS. 30A-30C and FIG. 31 illustrate the process.

In FIG. 30A, if the supervisor wishes to assign a custom (non-default) set of parameters to this key, he selects the “Edit Key Limits” option in the menu bar of the screen 1130 and then selects the “Set User/Key Limit” option from the drop-down menu (step 1138 of FIG. 30C). In response, the system program presents a drop-down list 1132 of keys (by names assigned to the keys) which also displays the expiration dates of the keys (step 1140 of FIG. 30C). Next, as shown in FIG. 30B, the parameter customization screen 1136 is displayed by selecting the user or key. This screen shows the key parameters since the last key refresh operation. For security reasons, the software tracks which supervisor last authorized limit changes. By clicking on the two buttons “View Present Limits” and “View Previous Limits,” the user can see when the last changes were made on the key and by which supervisor (step 1142 of FIG. 30C). On this screen, the pointer will move the curser to the parameter the user wishes to change. The user then enters the desired value (step 1144 of FIG. 30C). After typing in the change, another parameter may be selected and changed. When all parameters have been changed, the “Accept” button is selected to record the new parameters in the database (step 1146 of FIG. 30C). At the time these are stored, the name of the supervisor operating the computer is also stored to archive the authorization in case a key is given limits beyond their approved level and an audit of who assigned these unauthorized limits is required.

A “Disable FOB” button 1137 is provided in the screen 1136 to disable the key at its next refresh. In this regard, if the key reaches any of the limits, it will become disabled. The key will indicate that it is disabled by flashing brightly three times when the key is in the cradle and the transmit button of the key is pressed.

After the new parameters have been stored, prior parameters for this key are also kept in the database for easy viewing. In addition, the time and date of the prior docking event and the parameters can be stored and easily viewed.

Later, in a key refreshing operation, the button of the key is pressed on the key and the limit parameters are loaded into the memory of the key. FIG. 31 illustrates by way of example the process of re-calculating the limit parameters during the key refreshing operation. The program 1034 takes the limits defined for the key from the database (step 1150) and, at the time of refresh, using the existing date and time to calculate certain date specific limit parameters such as the date the key should expire and the days the key should operate (step 1151). Last, these parameters are loaded into the key (step 1152). This process allows the supervisor to maintain work schedules in the database for each employee and as long as the schedule does not change the expiration limits will be properly re-calculated at the time of each refresh. Thus, the supervisor does not need to maintain key parameters on a routine basis, as they are automatically calculated at each refresh based on the database information for each key.

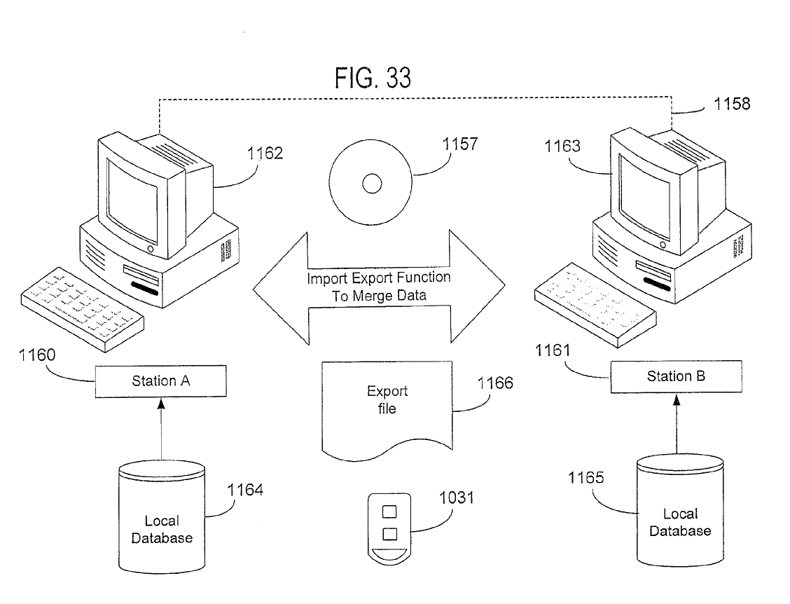

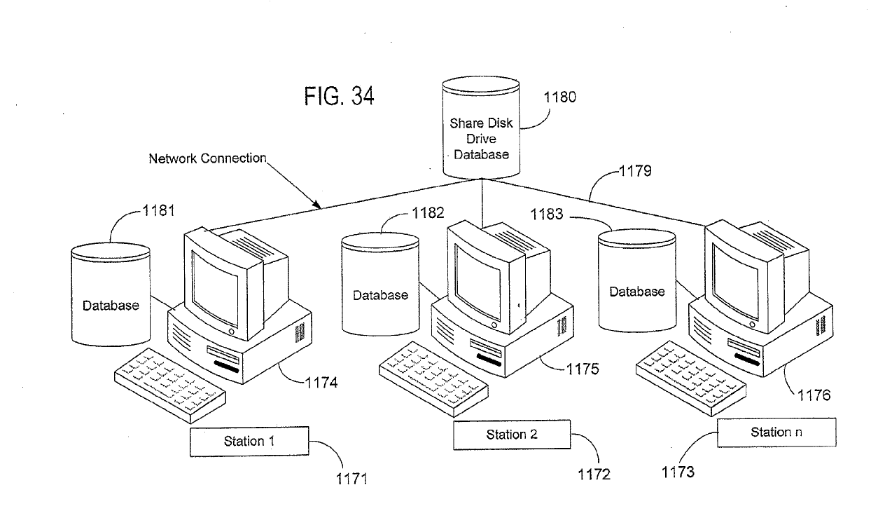

In accordance with an aspect of the embodiment, it is advantageous to provide the capability of more than one docking station or cradle to service the same keys and vending machine locks. This is accomplished by providing a mechanism for either (1) multiple cradles communicating with multiple databases, wherein these databases would be synchronized and merged from time to time (FIG. 33); or (2) multiple cradles communicating with a single central database (FIGS. 34-36). The advantages and disadvantages of each configuration are described below.

Multiple Cradles Communicating with Multiple Databases

In one configuration illustrated in FIG. 33, multiple cradles are located at multiple separate locations, with each cradle interfaced to a PC containing separate databases. For simplicity of illustration, FIG. 33 shows only two cradles 1160 and 1161 attached to computers 1162 and 1163, respectively, but more cradles and computers at other locations may be included. In the illustrated embodiment, the database 1164 is accessible to the computer 1162, and the database 1165 is accessible to the computer 163. The databases 1164, 1165 may be local to the computers 1162, 1163, respectively, or may be at remote locations and connected to the computers via network connections. It is possible to allow electronic keys to visit and be refreshed by more than one cradle/database. One way to accomplish this is to initialize each key into one cradle 1160 or PC database 1164. Once each key 1031 is initialized, the databases 1164 and 1165 may be synchronized. Synchronization is accomplished by exchanging the key and vending machine lock data from one database 1164 to another 1165 and vice versa until all databases share the same key and vending machine lock data. This may be accomplished, for example, by creating an “export” file by the export utility from each database that contains the key and vending machine data of the database.

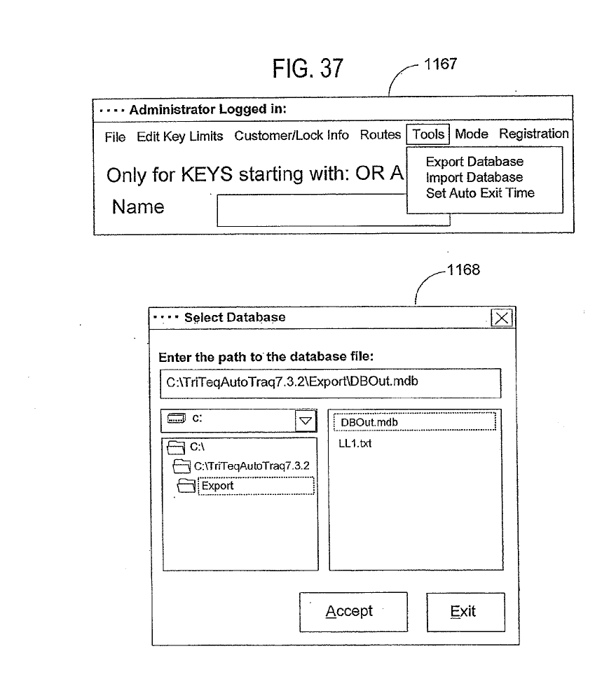

The user interface screens 1167 and 1168 for this operation are shown in FIG. 37. In the screen 1167, the user selects to export the database, and in the screen the user identifies the path to the database file. In the illustrate example, the export directory contains the file DBOut.mdb as the container of the export file. The export file may be stored on a transportable medium, such as a floppy disk, a CD ROM 1157, a USB key, a memory card, etc. Alternatively, the export file may be transmitted to another computer via a network 1158, preferably in an encrypted format to ensure the security of the transmission. This export file 1166 is next presented to another computer database by using the import utility. This import utility will search for data in the export file that is not in the local database, and load this new data into the local database. If the data presented by the export file is a duplicate of data already existing in the database running the import utility, the data is not imported as a duplicate and is discarded. For example, if a vending machine lock serial number and location is in the export file 1166 and presented to the database 1164 by the import utility, but already exists in the database, it is not entered into the database. This import and export procedure should be executed on a regular basis and the key and vending machine data will stay consistent in each database.

Multiple cradles communicating with a single database: In an embodiment of this configuration shown in FIG. 34, multiple cradles 1171, 1172, 1173 are located at multiple remote locations, each interfaced to a separate PC 1174, 1175, or 1176 that has access to a shared database 1180 via a network connection such as a local-area network (LAN) 1179. Since there is only one database, there is no need for synchronization. In this embodiment, each cradle and PC has access to send/receive data to/from the network-centralized database 1180. There are several issues about giving access to the central database 1180 to more than one computer. One such issue is if two computers attempt to access the database at the same time, data could be lost or over-written. Another concern is the time it takes to access and communicate with the database. For example, if a significant amount of data must be downloaded from a key at one station, this download process could take several minutes to finish. If another key is also trying to download data and receive new access limits from another computer and cradle, the waiting time could be significant.

Thus, it is a feature of the embodiment to provide multiple cradles with access to the same database and provide a fast refresh time so employees are not delayed waiting for their keys to be refreshed. One mechanism to accomplish this is for each computer 1174, 1175, 1176 to hold a refresh buffer 1181, 1182, or 1183 locally in its PC in order to allow for fast refreshes during busy working hours, and during non-work hours when network traffic is minimized the PC will upload it's data in the database 1180 on the network. Also in this example the local PC may use the refresh buffer as a local database, or use a separate database, for holding the key limit data. This allows fast refresh of key limits, and would store the audit trail data in the buffer. A copy of the shared database is downloaded from the shared drive by each station and stored locally. In the case the connection to the shared database 1180 is interrupted, each individual station can continue servicing keys without interruption using the local database. In this mode, typically no changes or additions are allowed to the database such as key limits and vending machine information.

Database Compacting and Archive

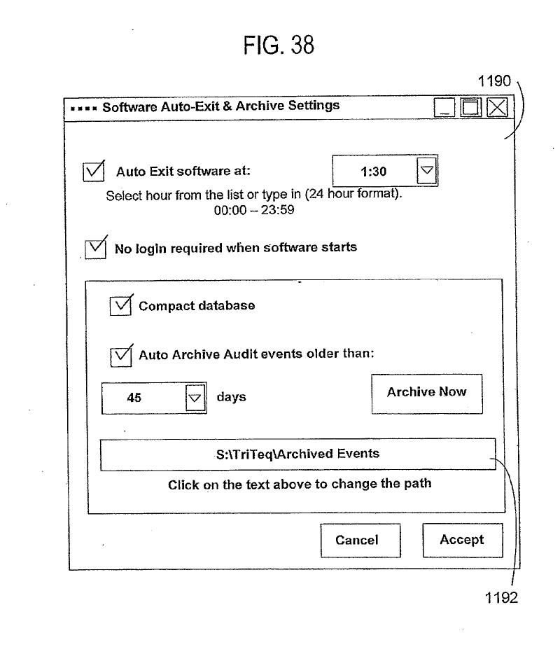

Compacting and Archiving of the database are tasks that need to be executed at a frequency dependent on the amount of data that is being added to the database. The more data that is added, the more frequent these task should be executed. In one embodiment, the system allows the user to select an automatic compacting and archiving of the audit trail data. Also allowed is selecting automatic exiting of the software and automatic login of the software at selected intervals. FIG. 38 shows a user interface screen 1190 for a user to select the parameters. In this example, the user selects the system will automatically compact and archive each 45 days. Also selected is the path & location of the archive 1192. In addition, the system is capable of monitoring the amount of data entering the database and executing an automatic compaction and archive if a certain volume of data is moved into the database.

System Start/Exit

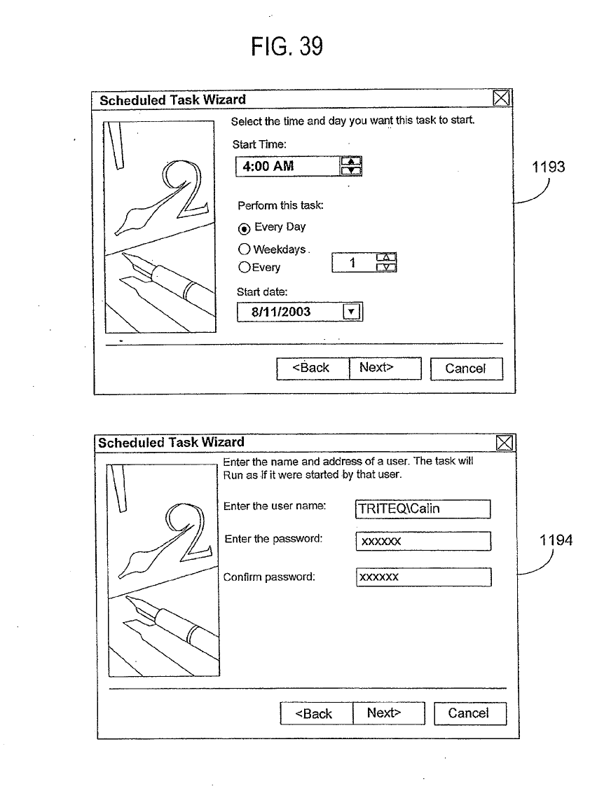

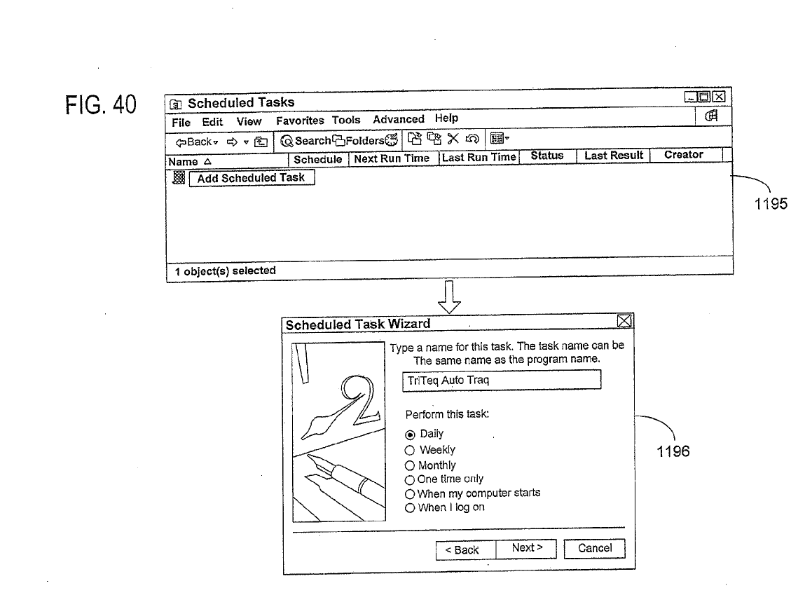

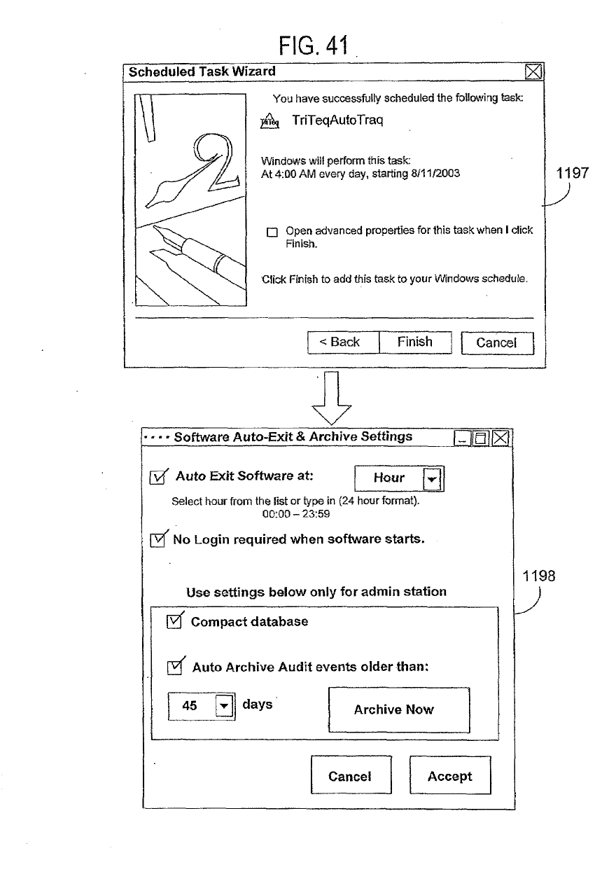

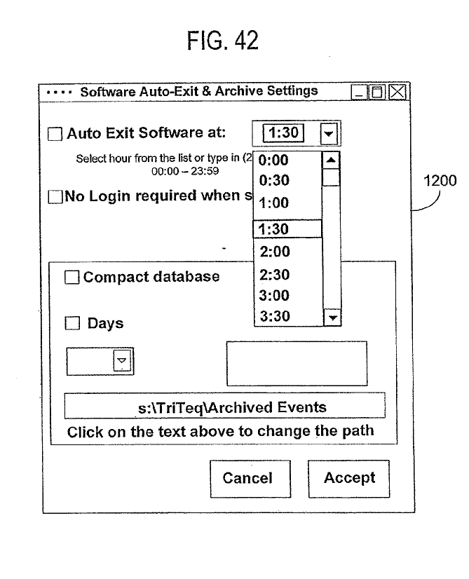

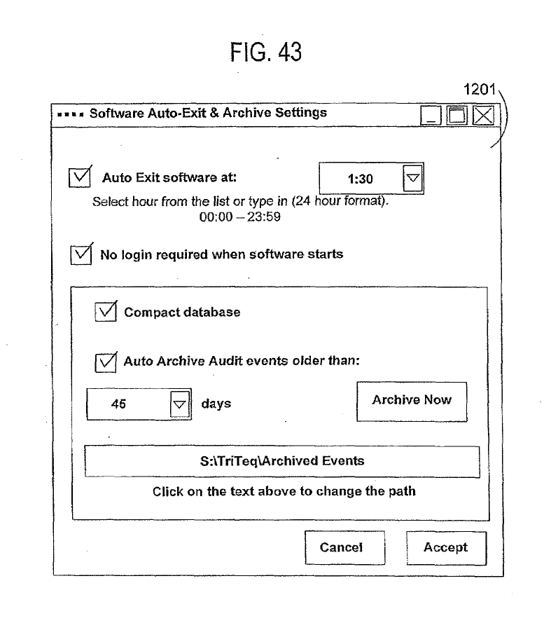

The system is capable of automatically starting up and exiting from operation on a daily basis. The start and stop times can be pre-determined and entered into the system as a scheduled task. FIGS. 39-41 show a sequence of user interface screens 1193, 1194, 1195, 1196, 1197, 1198 to illustrate an example of how the system is scheduled to start-up at 4:00 AM every day. FIGS. 42-43 contains user interface screens 1200, 1201 that illustrate an example of how the user selects the system to automatically exit from operation at 1:30 AM each day.

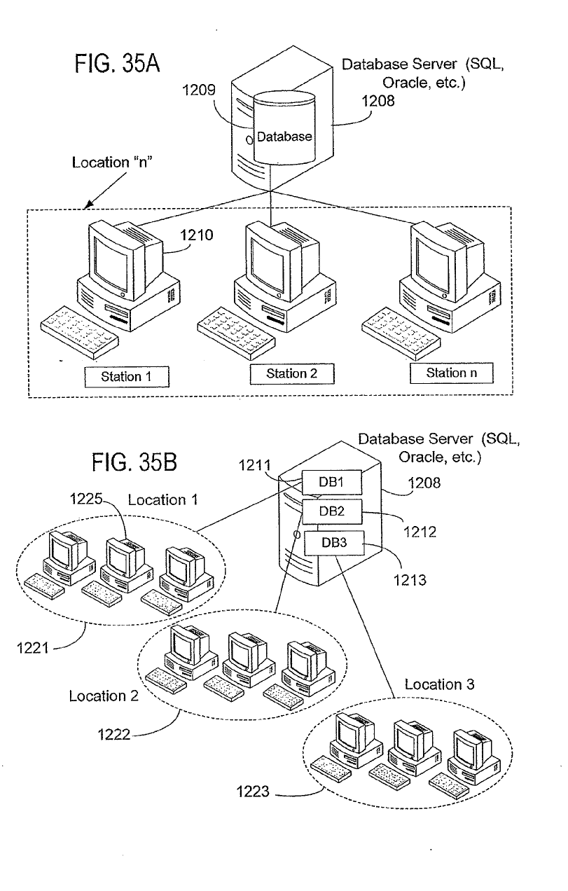

In an alternative embodiment illustrated in FIG. 35A referred to as the pre-enterprise configuration, the single database configuration uses a dedicated database server 1208. This configuration contains all of the above-described features from the LAN network single database embodiment, while each station is allowed to access a dedicated database server 1208 (SQL, Oracle, etc). A local station 1210 connecting to the database 1209 will be accomplished using the standard “Data Source (ODBC)” included in all Windows operating systems. After connection to database is accomplished, the user uses the key control operation features the same as in the previous configuration. Potential advantages of this configuration are increase database reliability, faster response time on accessing, changing, or adding records to the database, and significantly less data traffic.

Referring to FIG. 35B, the added capacity of a dedicated database server 1208 can be used by mounting multiple databases 1211, 1212, 1213 for serving multiple locations 1221, 1222, 1223, respectively. In such instances the databases 1211, 1212, 1213 can be identified by the specific city code, or group of city codes each database represents. A location can be, for instance, a cluster of bottling stations and/or a bottling station and several satellite locations. Stations from each location are assigned rights to access only the database they are associated with. For instance, computers at the location 1221 may access only the database 1211, and computers at the location 1222 may access only the database 1212. This configuration adds the benefit of creating global access reports that will include reports from all locations. Another benefit of this configuration is the option of remote control and administration of database from a remote location. For example, if appropriate rights are assigned to Station 1225 at Location 1221, this station can manage keys, users and vending machines at location 1221 as well as the other locations. By using a LAN type network, the security of this configuration should adequately prevent hackers from gaining access to the database and the security of the system.

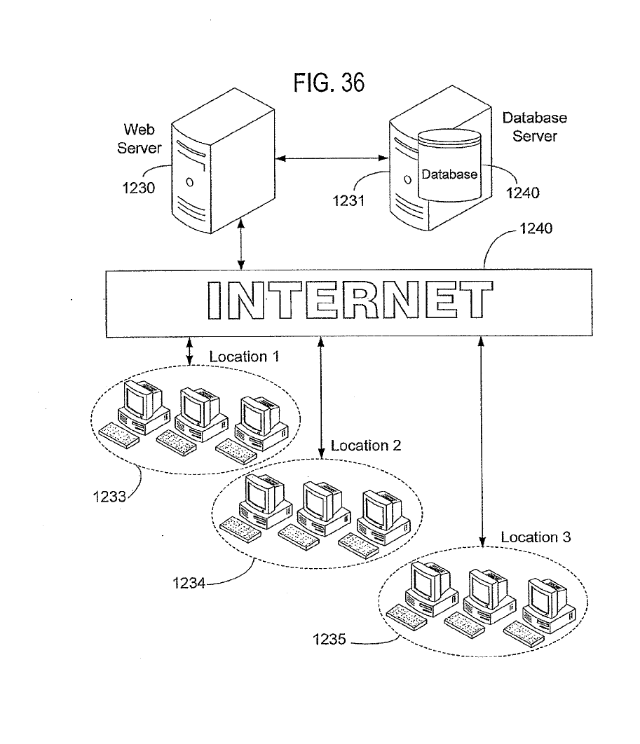

In another alternative embodiment of the single database configuration illustrated in FIG. 36, a web server 1230 connected to a database server 1231 is used. This configuration is referred to as the Enterprise configuration. Each of the individual stations uses a simple web browser (e.g., Internet Explorer, Netscape, Opera, etc.) to communicate with the web server 1230 to access the database or databases 1240 maintained by the database server 1231. In this way, the individual stations can accomplish functions related to key refresh, adding keys and users, adding vending machines and asset numbers, and modify key settings as in the previously described configurations. In the event of lost Internet connection, the stations in this configuration operate a simplified version of the software as described in FIGS. 34 & 35 for refreshing keys while the connection with the web server 1230 is severed. One benefit of this configuration is the ability to use the Internet infrastructure to create a wide-area network for remotely operating the stations and thus eliminate the need to support a separate or dedicated structure to accomplish the same. Another benefit of this configuration is that software updates for the functionality of the stations as well as adding and deleting stations will be done in the web server and may not require user intervention at the station when these tasks are performed. One potential disadvantage is that hackers may attempt to get access to the database since the network is accessible to almost anyone with a browser and access to the web.

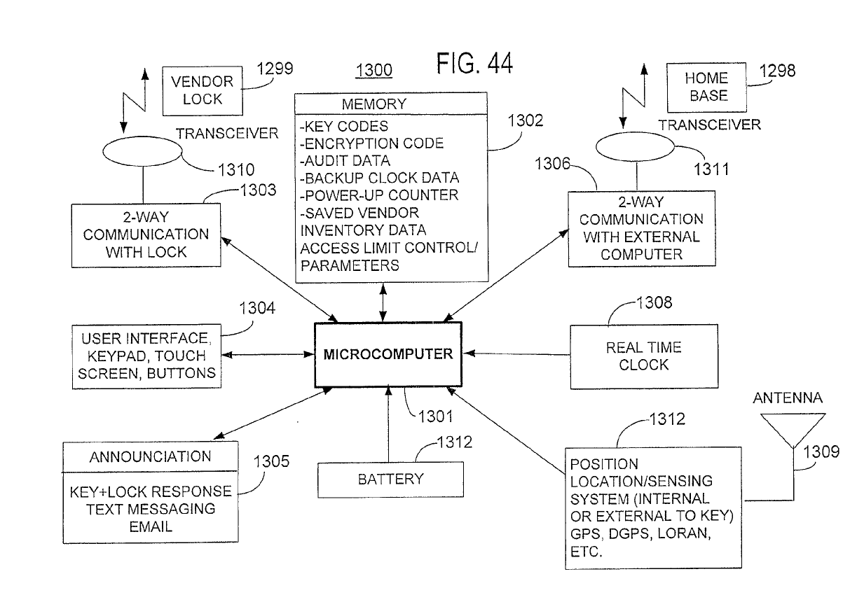

An enhanced electronic key may be provided with additional hardware and software features to enhance the security, tracking, audit data control, and assisting of the employee to fill and service the vending machine. FIG. 44 is a functional block diagram of the enhanced electronic key 1300. The key 1300 has a microprocessor or microcomputer 1301, a non-volatile memory 302, a real-time clock 1307, and a battery 1312 for powering the components of the key. The memory 1302 may contain software and data required for the operation of the key, such as key codes, an encryption code for use in encrypting and decrypting communications with an electronic lock, encryption/decryption algorithms, backup clock data, power-up counter. The key memory may also contain data collected form vending machines, such as access audit data and vending machine inventory data.

The key 1300 includes a two-way communication module 1303 with a transceiver 1310 for two-way communications with the electronic lock 1299 of a vending machine. The key may also include user interface features 1304 such as a keypad, touch screen, or buttons with specific functions. An annunciation component 1305, such as LCD screen, may be included for displaying key-lock responses, text messaging, email, etc. The key may include another two-way communication component 1306 that has a transceiver 1311 for communicating wirelessly with a home-base 1298.

As a feature of the embodiment, the electronic key 1300 may further include a position sensing component 1308 for identifying the current location of the key. This component, which may include an antenna 1309 and may communicate with a location sensor, which may be internal or external to the key and may be based on one of the positioning systems such as GPS, DGPS, LORAN, etc. When an external location sensor is used, the component 1308 functions as an interface for receiving location information from the external location sensor. The external location sensor preferably has the capability to record time and location data independently of the key 1300, and preferably is able to store an identification name or number to identify which user it is collecting data for. The data stored by the external location sensor may later be used as part of audit trail data for tracking and managing the field devices.

The advantage of including the position sensing system component 1308 in the key is the ability to track the location of each key used to access the vending machines. For example, electronic keys that include location tracking would pinpoint the geographical location of each vending machine the user of the key was attempting to access. Thus, and audit event for an access attempt would consist of the user of the key, the key code, the date and time of the attempt, the limits (if any) of the key, the serial or ID number of the vending machine, and the physical location (preferably at least 2-dimensional latitude and longitudinal coordinates, and possibly the third dimensional or altitude coordinate) of the vending machine being accessed. These coordinates could be translated by computer to common street address and location (for example, 100 W. Plainfield Rd, Countryside, Ill., second floor, suite 202).

When an electronic key has the capability of obtaining the location coordinates of a vending machine (either by receiving these coordinates itself by a position sensing system or by communication with a position sensing system at the vending machine location), the previously described step of reading the serial number of the vending machine (with a reader tool, or a bar code reading device, or by the electronic key) and entering the vending machine location data into the computer 1032 manually may be eliminated. Since the electronic key will produce or receive the location coordinates at the time it attempts to access the vending machine, this data can be provided to the database as the vending machine location in lieu of a manual entry, which is subject to human error.

An additional benefit of the position sensing feature in the electronic key 1300 is the ability to keep track of and/or locate keys if they are lost or stolen. Since this key has the data exchange feature described above, it can transmit its location coordinates to the central or home-base location or to a person possessing a computing device that would receive the location information.

An additional feature of this key 1300 is the data transfer capability. In additional to its capability of transferring data in short range to the docking cradle (as described for other keys in this system) this key may be equipped with the capability to transmit and receive data over longer distances. Thus, as a key is being operated the audit data and the vending machine sales and inventory data would be transferred back to a central or home-base location. The enhanced communication capabilities would include text messaging and email in order for the person using the key to send and receive information concerning the route they are working on, changes and additions, reports, etc.

In another implementation based on the embodiment described in FIG. 44, the electronic key 1300 utilizes the GPS position data to decide if it is enabled for operation. To that end, the electronic key 1300 includes additional registers or memory space, such as in the memory 1302, for storing limiting parameters concerning the relative position of the key for deciding whether the key should be enabled or disabled. The position limiting parameters may, for example, specify the coordinates of areas in which the key 1300 is allowed to be used to access locks of vending machines. The position limiting data may be downloaded to the key 1300 during a refresh operation when the key is placed in the cradle of the key management system (e.g., at the bottling facility) as described earlier. Alternatively, the position limiting data may be received by the key 1300 wirelessly via the transceiver 1311 when the key is in the field. Besides the position limiting parameters, the memory 1302 of the key may store other access limit parameters, such as days of the week, number of days, number of access events, hours of the day, etc.

In operation, the GPS receiver 1308 receives position data indicating the current position coordinates of the key 1300, and forwards the data to the processor of the key. The key 1300 compares the received position data with the position limiting data stored in it to determine whether the key is in a valid territory for operation as specified by the position limiting data. If the key is in a valid territory for operation, when key is actuated by the user, it will proceed with the unlocking operation, if the other operation limiting parameters are not exceeded. If, however, the key is not located in a valid territory, it will enter a disabled mode and cannot not used for accessing locks. If the key is later moved into a valid territory, it receives updated position coordinate data from the GPS receiver and determines that it is now in a valid territory, and returns to the enabled mode so that it can be used to access locks.

In accordance with a feature of invention, the concept of associating the location information with events of accessing a device in the field or controlling the operations of the device can be applied to various types of devices in different scenarios. One example of such an application is already described above in connection with the embodiment of FIG. 44, in which an electronic key 1300 is used to access a vending machine, and the location of the vending machine is one of the parameters used in determining whether the key should be allowed to open the lock of the vending machine. Other applications may involve field devices such as appliances, shipping containers, power tools, etc. As used herein, the term “appliances” includes vending machines, coolers, fountain drink dispensers, and other similar devices operated by AC power, DC power, or batteries. The types of operations of the devices to be controlled would depend on the particular devices.

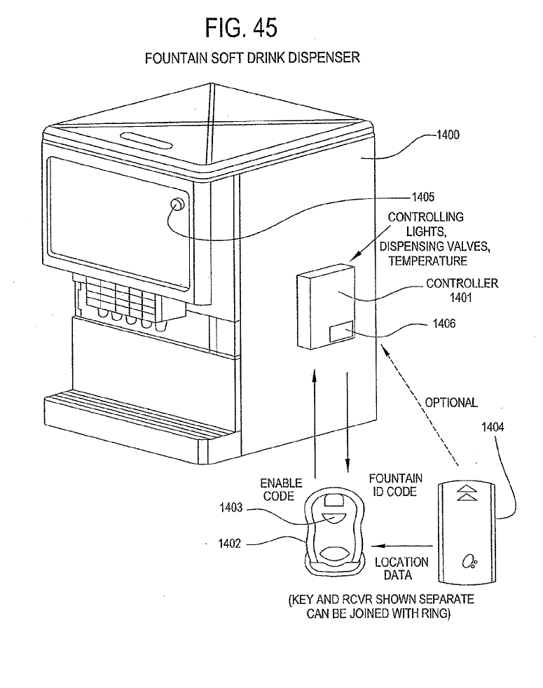

By way of example, FIG. 45 shows a fountain drink dispenser 1400. In contrast to a vending machine, the fountain drink dispenser does not have openable door or closure guarded by a lock. Nevertheless, the dispenser 1400 has other functions and operations that can be controlled or enabled/disabled.

To that end, the dispenser has a controller 1401 that controls the functions and/or operations of the dispenser using actuator components such as motors, solenoids, relays, solid state switches, etc. The controller 1401 may be installed inside the appliance behind a surface wall of the appliance, or alternatively mounted on an outside surface of the appliance. The controller 1401 interacts with a mobile control device, which may be used to activate the dispenser at selected intervals. The mobile control device may be, for instance, an electronic key 1402 similarly constructed and programmed as the electronic key 1300 of the embodiment in FIG. 44. After being activated or enabled, the dispenser 1400 may work for a predetermined time period, such as one month, and then stop to be operational unless it is activated again by receiving an enable code from the key 1402. For instance, the controller 1401 of the dispenser 1400 may be programmed to control the components of the dispenser such that the lights or the dispensing valves cannot be turned on, or the refrigeration unit does not operate to cool the drink to a regular temperature, unless it is enabled by the key. As another example, the appliance may require preventative maintenance and may turn on an indicator such as a “Maintenance Required” light 1405 after the machine has been in operation for a predefined period of time. In that case, the key 1402 can be used to turn off the indicator light and restart the service period when it visits the appliance. This arrangement allows the owner of the appliances in the field to track whether the appliances are properly maintained as required.

As illustrated in FIG. 45, when the electronic key 1402 is used to control the operations of the dispenser 400, the key establishes communications with the dispenser controller 1401. As part of the communication process, the dispenser controller 1401 sends the device ID of the dispenser to the key 1401. The key 1402 also obtains information regarding the current location of the dispenser 1400, either before, substantially simultaneously with, or after receiving the device ID. The location information may be provided by a location sensor built into the key, or from an external location sensing device, such as a GPS receiver 1404. When the key 1402 is actuated to communicate with the disperser controller 1401, it also establishes communications with the external location sensing device 1404 to obtain the location data. Alternatively, the location information may be first transmitted from the external location sensing device 1404 to the dispenser controller 1401, and then transmitted by the controller to the key 1402 as part of the communications between the key and the controller. In that case, the controller 1401 includes an interface 1406 for receiving the location data from the location sensing device 1404. One significant advantage of using a location sensor that is mobile, instead of one with a fixed location or one installed in the field device being tracked, is that the mobile location sensor can travel with the key to visit field devices at different locations. Thus, one location sensor can be used to provide the location information for many field devices. This results in a significant reduction of cost as compared to having multiple location sensors in fixed locations or installed in respective field devices.

In a preferred embodiment, the location information may be used by the key 1402 to determine whether the dispenser 1400 should be enabled. For instance, the memory of the key 1402 may have stored therein allowed or valid location(s) of the dispenser 1400 associated with the dispenser ID. The key 1402 can compare the current location of the dispenser with the allowed location data in its memory to determine whether the dispenser is at a valid location. One aspect that makes this arrangement advantageous, as compared to storing the valid location information in the field device and using the field device to do the location validation, is that a person responsible for visiting the field devices is normally associated with a key, not a particular field device. Thus, this arrangement allows control of both (1) the assignment of the key to the employee, and (2) the location at which the key is allowed to access or enable a field device.

If the current location for the dispenser 1400 is valid, the key proceeds to enable the dispenser or otherwise control the operations of the dispenser. As used herein, “enabling” a field device means to give authorization to the controller of the field device to enable one or more functions of the field device other than the unlocking or locking of a closure such as a door. If the actual location of the dispenser is, however, different from the valid location stored in the key, the key may decide not to enable the dispenser. Preferably also as part of the communication process, the key 1402 may transmit its key ID to the dispenser controller 1401. This allows the dispenser controller 1401 to learn which key is used to access it so that it can include that information in an audit trail record. The audit trail data concerning the control events, as well as other audit trail data concerning the usage of the dispenser over the last enabled operation period, can be downloaded to the key as part of the communication process.

The communications between the controller 1401 of the dispenser 1400 and the mobile control device 1402 may be wire-to-wire (i.e., through a cable connecting the dispenser controller and the mobile control device) or wireless (e.g., via RF or infrared transmissions). Non-encrypted communications may be used, but preferably encryption/decryption methods are used to protect the contents of the communications from eavesdropping.

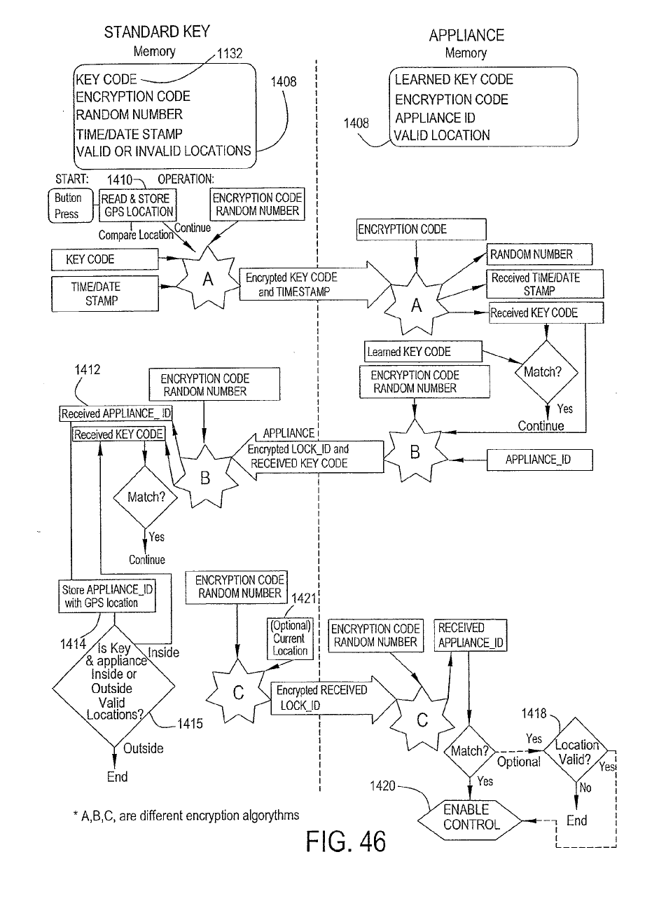

When encryption/decryption is used to protect the communications, the communications may be performed according to the data flow diagram shown in FIG. 46. This flow diagram is generally similar to that shown FIG. 7, but with several additional steps performed in connection with location validation. Specifically, the memory 1132 of the key 1402 includes data representing the valid or invalid locations for one or more appliances in the field. When the user starts the communication process by pressing the button 1403 on the key 1402, the key first reads and stores the current location data 1408 (step 1410). When the key receives the appliance ID from the controller of the appliance (step 1412), it stores the appliance ID with the location data as part of a control event record (step 1414). The key then determines whether it or the appliance is within the valid location for that appliance by comparing the actual location data with the location data stored in its memory (step 1415). If the appliance is outside its valid location, the key terminates the communication process (step 1416). As a result, the appliance may not be enabled for further operation. If, on the other hand, the appliance is in a valid location, the key continues with the communication process to ultimately enable the appliance (step 1420).

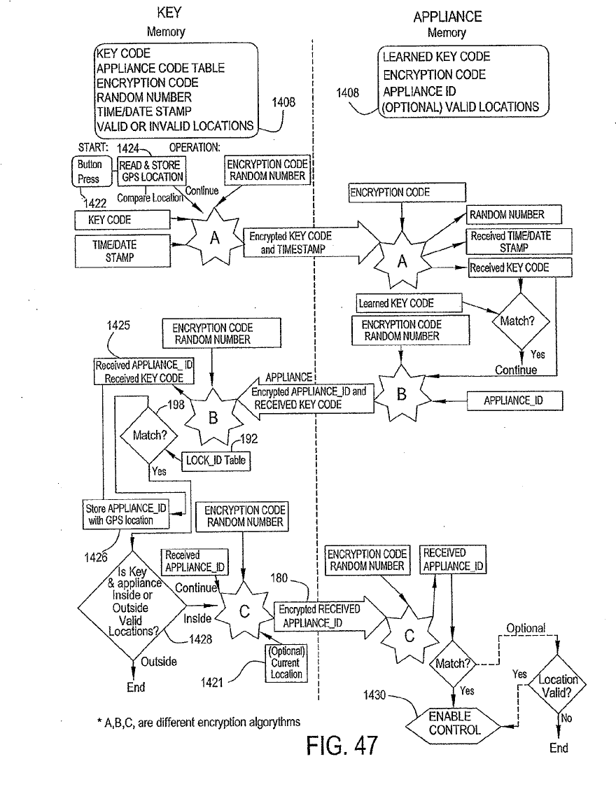

An alternative secured communication process for the key and the appliance is shown in FIG. 47. This data flow diagram is similar to that shown in FIG. 8, but with additional steps for location validation similar to those in FIG. 46. Again, when the user starts the communication process by pressing the button on the key (step 1422), the key first reads and stores the current location data (step 1424). When the key receives the appliance ID from the controller of the appliance (step 1425), it stores the appliance ID with the location data in a control event record (step 1426). The key then determines whether it or the appliance is within the valid location for that appliance based on the location data stored in its memory (step 1428). If the appliance is outside its valid location, the key terminates the communication process. As a result, the appliance may not be enabled for further operation. If the appliance is in a valid location, the key continues with the communication process to ultimately enable the appliance (step 1430).

In an alternative embodiment, the determination of whether the field device is at a valid location may be made by the controller of the field device, instead of the mobile control device. As shown in FIG. 46, the controller of the appliance may have the valid (or allowed) location data 1408 stored in its memory. To perform the location validation, the controller would require information regarding its current location. The controller may include an interface for receiving location data from a built-in location sensor or an external location sensor, such as a GPS receiver. Alternatively, the controller may receive the current location data from the key. To that end, the key may include the current location data 1421 as part of the encrypted transmission 1419 it sends to the appliance controller during the communication process.

In this optional arrangement, also shown in FIG. 46, the step 1415 of determining whether the location is valid is not performed by the key. Instead, it is now performed by the appliance controller (step 1418) by comparing the location data provided by the GPS sensor with the allowed location data stored in the memory of the appliance controller. If the location is valid, the controller enables the operation of the appliance. Similarly, in the alternative communication flow in FIG. 47, the current appliance location data 1421 may be transmitted to the appliance controller as part of the encrypted transmission 1430 to the appliance controller, and the step 1428 performed by the key to validate the location by comparing the current location with the allowed location is replaced by the step 1429 performed by the appliance controller.

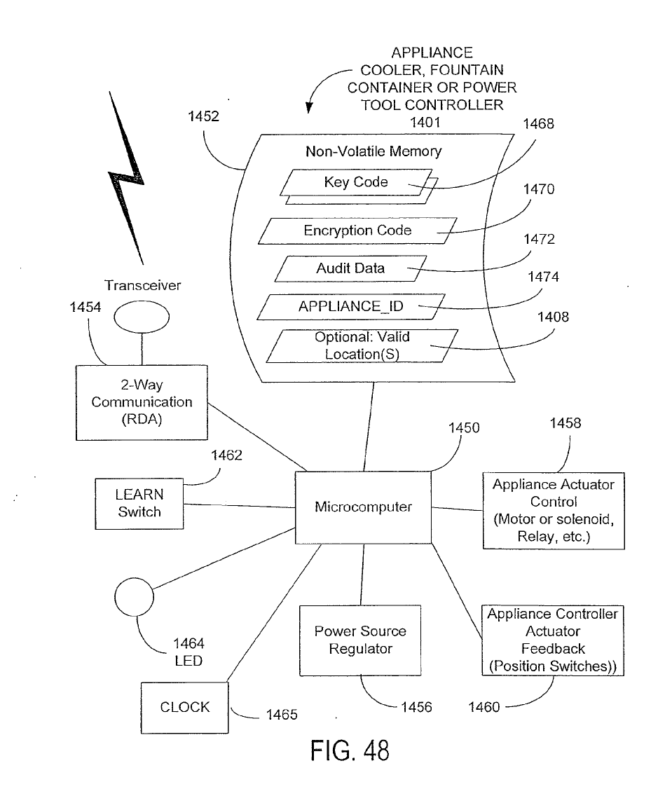

FIG. 48 shows in a functional block diagram the circuitry for a controller 1401 that may be used to control the operation of an appliance. Even though the embodiment in FIG. 48 is described as for controlling an appliance, it will be appreciated that it may also be used for controlling the access or operations of other types of field devices. The controller 1401 comprises a microcomputer 1450, a non-volatile memory 1452, a half-duplex IRDA infrared communication interface 1454 for communicating with an electronic key, a power supply voltage regulator 1456, an appliance actuator control 1458, an appliance operation actuator feedback 1460, a learn switch 1462 similar to the one mentioned earlier in another embodiment, and the LED 1464 for state indication. The non-volatile memory 1452 stores key codes 1468, encryption codes 1470, audit data 1472, and a device ID 1474 that identifies the appliance. The appliance operation actuator control 1458 may contain circuitry for controlling actuator components such as motors, solenoid, relays, etc., the actuation of which enables or disables one or more functions of the appliance. The actuator feedback 1460 provides feedback signals to the microprocessor for confirming the actuation states of the actuators. A clock 1465 provides time information so that the microprocessor 1450 can perform decisions such as whether the enabled operation period has expired and the machine should be disabled or whether the preventative maintenance indicator should be turned on.

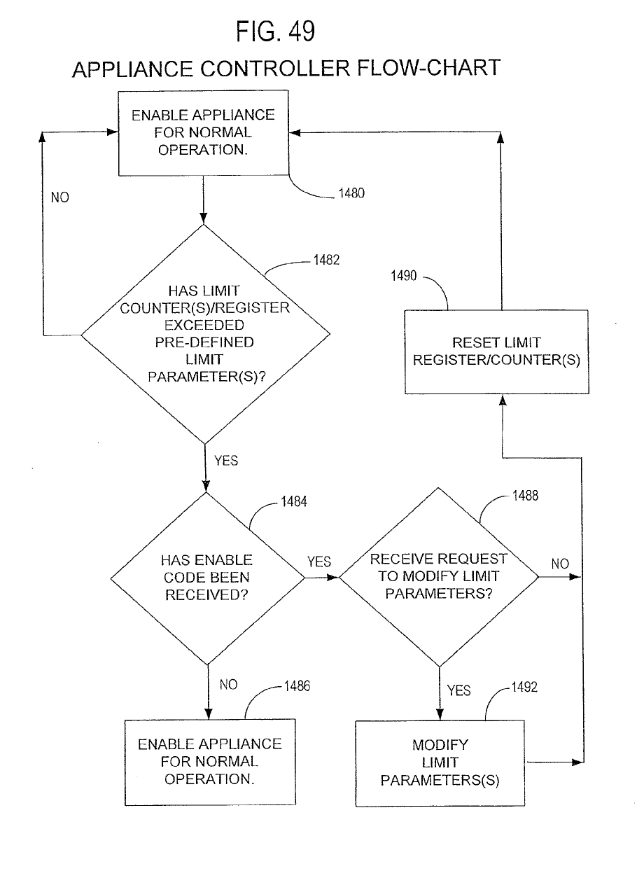

The device control process performed by the controller 1401 of the appliance is generally illustrated in FIG. 49. The process starts at a state in which the appliance is enabled for normal operation (step 1480). The controller periodically checks whether the value in any of the limit counters or registers in its memory has exceeded a pre-defined limit parameter value (step 1482). The limit parameters include, for instance, the time period in which the appliance is allowed to operate. If no limit parameter has been exceeded, the controller returns to the state of normal operation. If, on the other hand, a parameter has exceeded its predefined limit value, the controller determines whether an enable code has been received (step 1484). If no enable code has been received, the controller disables the operations of appliance (step 1486). If an enable code has been received, the controller determines whether any request to modify limit parameters has been received (step 1488). If no, the controller resets the limit registers and counters (step 1490), and return to the normal operation state. If a request to modify limit parameters has been received, the controller modified the limit parameters as requested (step 1492). The controller then resets the limit registers and counters, and returns to the normal operation state.

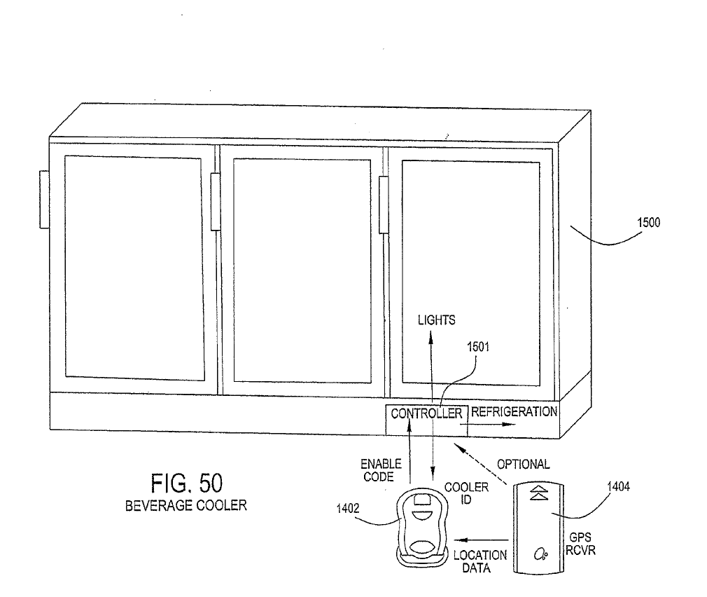

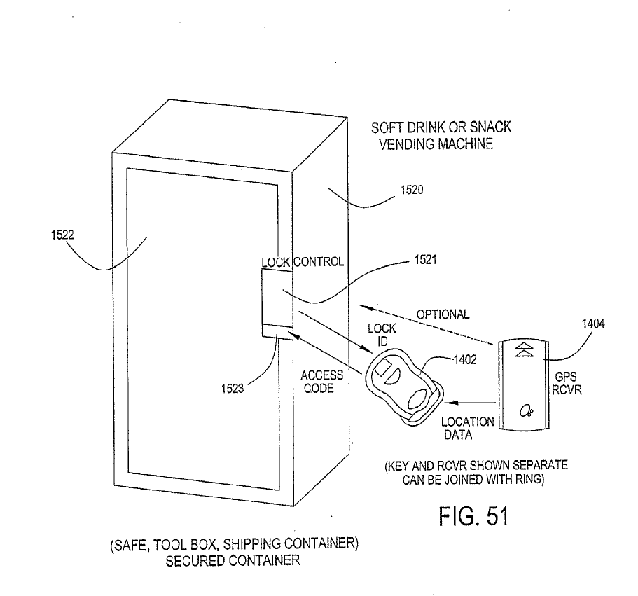

As mentioned above, the collection and use of location data as part of a process of accessing or otherwise controlling the operations of a field device can be advantageously used in many different applications. A few more examples of such applications are provided below. FIG. 50 shows a beverage cooler 1500. The functions of the cooler, such as lighting and refrigeration, are controlled by a controller 1501, the construction of which may be similar to that described in FIG. 48. An electronic key (or a mobile control device) 1402 is used to control the operations of the cooler 1500 by enabling or disabling the functions of the cooler. To that end, the key 1402 initiates a communication process with the controller 1501 of the cooler. As part of the communication process, the key obtains location data indicating the current location of the cooler. The location data may be received from an external location sensing device 1404. Alternatively, the key may receive the location data from the cooler controller 1501 which in turn receives the location information from the external location sensing device 1303. The key 1402 also receives from the controller 1501 the device ID for the cooler 1500. If the key determines that the cooler is in a valid location, and other operation limit parameters are not exceeded, it transmits an enable code to the cooler controller 1501, thereby enabling the cooler to operate for a pre-selected period, such as six months. As part of the communication process, audit data concerning the usage of the cooler may be downloaded from the controller 1501 to the key 1402.

As another example, FIG. 51 shows a container 1520 having a door 1522 or closure secured by a lock 1523 controlled by a controller 1521. The container may be a safe, a tool box, or a shipping container, etc. The container 1520 may be placed at a fixed location, as in the case of a safe, or may be mobile as in the case of a truck-mounted tool box or a shipping container. A key 1402 is used to access the container to unlock the door 1522. The key 1402 receives data representing the current location of the container from an external GPS receiver 1404 directly or indirectly through the lock control 1521. The lock control 1521 transmits the lock ID to the key 1402. Based on the lock ID and the currently location data and the permitted location data stored in its memory, the key 1402 determines whether the container 1520 is at a valid location. If the container 1520 is at a valid location, and other operation limit parameters are not exceeded, the key 1402 transmits an access code to the lock controller 1521, which in response opens the door 1522.

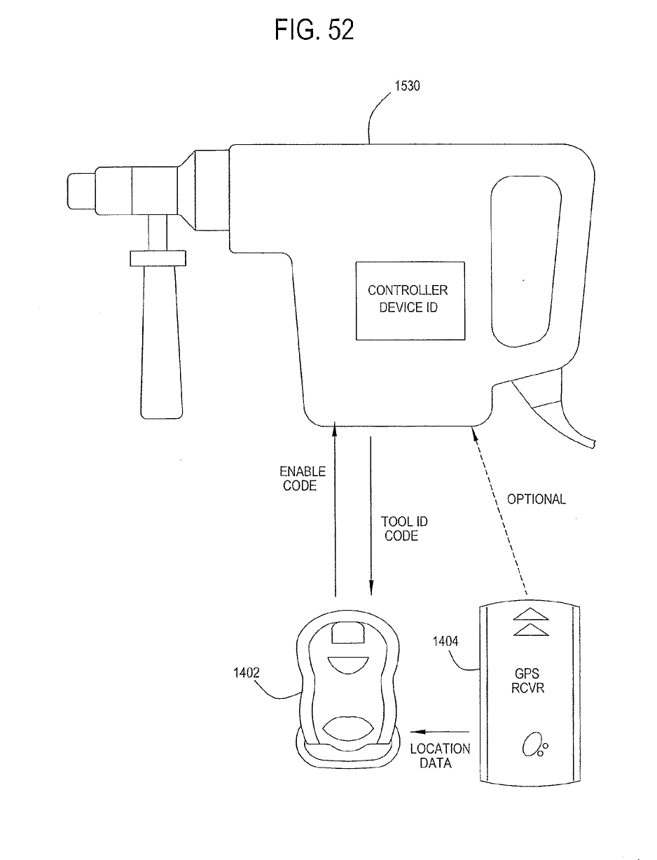

As a further example of a field device, FIG. 52 shows a power tool 1530, the operation of which may be enabled or disabled by a mobile control device such as a key 1402. The power tool 1530 includes a controller 1531, which is programmed to disable the power tool, such as by using a switch or relay to cut off power, if the power tool is not enabled. In the enabling operation, the key 1402 receives the current location from the GPS receiver 1404 and the device ID from the power tool controller 1531, and determines whether the power tool 1530 is at a valid location. If the location is valid and other operation limit parameters are not exceeded, the key 1402 transmits an enabling code to the power tool. The tool controller 1531 than enables the power tool to operate, such as by allowing electrical power to be passed to the power circuit of the tool. Once enabled, the power tool 1530 may operate for a pre-selected period, such as 24 hours, after which it has to be enabled again in order to operate further.

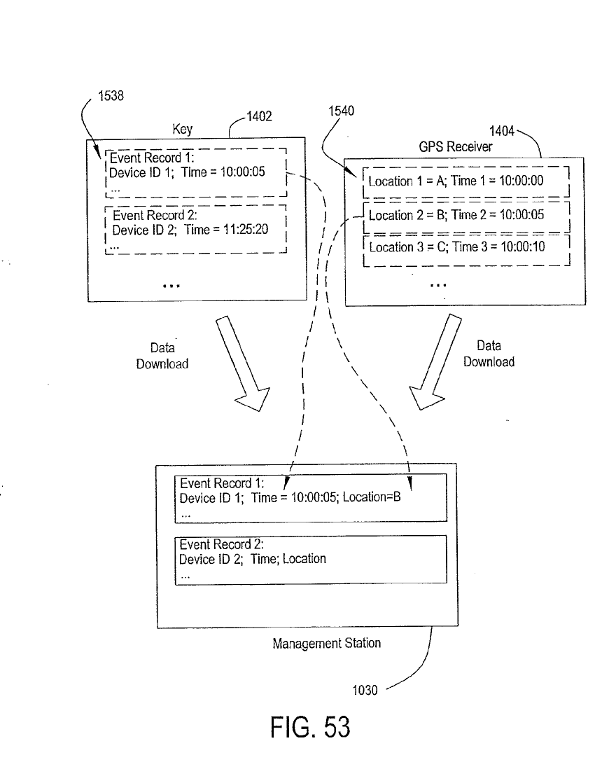

Turning now to FIG. 53, in an alternative embodiment, instead of storing the location data for each access/control event in the key memory as part of the access/control event records, the location data may be stored in the external location sensing device and used later to reconstruct the event records. For instance, referring to the embodiment in FIG. 45, the key 1402 and the GPS receiver 1404 may be joined, such as being placed on a key chain, so that they travel together. Alternatively, the GPS receiver 1404 may have a fixed location, such as adjacent to the field device being tracked, or may be mounted to something that is external to the field device or the key and is mobile, such as a truck of the route operator. When the GPS device is mounted in a transportation vehicle, the GPS location might be limited to the location of the transportation vehicle instead of being the exact location of the appliance.

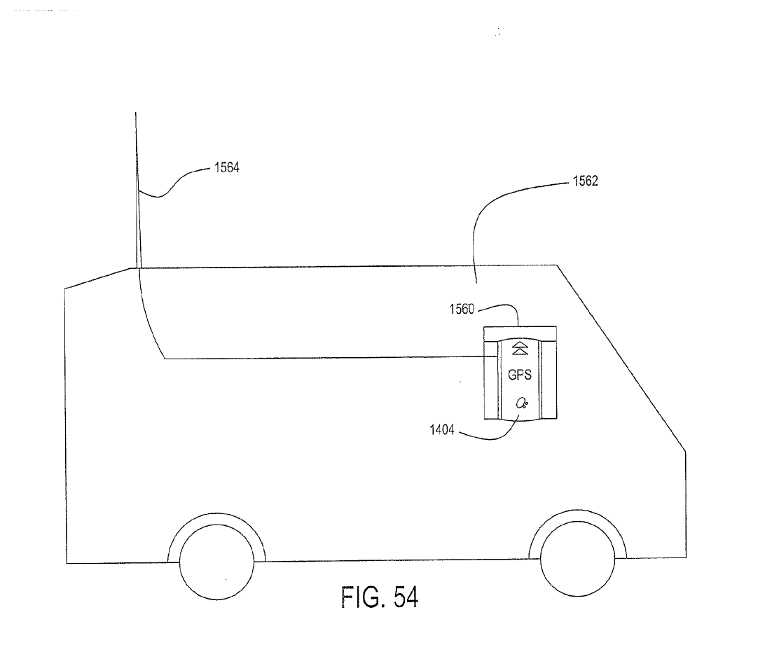

In another alternative embodiment shown in FIG. 54, the GPS receiver 1404 is normally plugged into a cradle 1560 in a transportation vehicle 1562 but can be removed from the cradle to allow it to be carried to the site of the filed device. Thus, if the reception of the GPS satellite signals at the site of the field device is good, the GPS receiver 1404 can provide the accurate location of that site. Otherwise, the location of the vehicle 1562 provided by the GPS receiver when it is received in the cradle 1560 can be used as an approximate position for the field device being visited. The cradle 1560 in the transportation vehicle 1562 preferably is configured for recharging the battery of the GPS receiver 1404, and to enhance the reception of the GPS satellite location signals by connecting the GPS receiver 1404 to an antenna 1564.

In operation, the GPS receiver 1404 records in its memory the location data and the actual (or real) time on a regular basis, such as every 5 seconds. Each time the key 1402 is used to communicate with an appliance such as a fountain drink dispenser, it stores the device ID of the appliance and the time of the control event, but not the location information, in its memory as a control event record. The key 1402 may be used to enable multiple dispensers or other appliances in a work day. When the key 1402 and the GPS receiver 1404 are returned to the home base at the end of a day, the control event records 1538 are downloaded from the memory of the key into the management station computer 1030, as shown in FIG. 53. The location data 1540 as a function of time are also downloaded from the memory of the GPS receiver 1404 into management station. The management station 1030 then matches the timing of the control event records with the timing of the location records to identify the location for each control event. In this way, a complete control event record with location information can be reconstructed by the management station 1030. This approach has the advantage of reduced complexity and cost of the electronic key and the GPS device, as they are not required to have respective communication ports to allow them to communicate with each other when the key is operated. Preferred embodiments of this invention are described herein, including the best mode known to the inventors for carrying out the invention.

Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A key management system for management of electronic keys used to access electronic locks, comprising:
an electronic key including operation limit parameters for determining if the key shall be rendered disabled in accessing the electronic locks, and a memory for storing audit trails data collected from electronic locks accessed using said key;
a computer employing an operating system for operating a plurality of tasks, wherein at least one task being a software program for key management functionality;
a database containing key management data; and
a cradle communicating with the computer for interfacing the computer with an electronic key;
the software program having computer-executable instructions for performing a key refreshing operation, said operation consisting of one of the plurality of tasks operating with the steps of:
receiving a transmission from a key through the cradle and receiving a key identification number from the key through the cradle;
receiving the audit trails from the key and storing the received audit trails data into the database;
retrieving from the database operation limit parameters based on the key identification number; and
sending the operation limit parameters through the cradle to the key.

2. A key management system as in claim 1, wherein the database contains a unique authorization number.

3. A key management system as in claim 1, wherein the computer receives an initial transmission from a key through the cradle, the initial transmission initiating the key refreshing operation.

4. A key management system as in claim 1, wherein the key and cradle engage in encrypted challenge-response communication.

5. A key management system as in claim 1, the software program further comprising computer-executable instructions for allowing a user to modify key operation limit parameters during a first operation mode, and for restricting a user from modifying key operation limit parameters during a second operation mode.

6. A key management system as in claim 1, wherein the software program includes computer-executable instructions for presenting a user interface screen for prompting an authorized user to set operation limit parameters for an electronic key, and saving the operation limit parameters for the electronic key into the database.

7. A key management system as in claim 6, wherein the software program includes computer-executable instructions for presenting a user interface screen for a system administrator to add or delete a user having authority for setting operation limit parameters for electronic keys.

8. A key management system as in claim 1, wherein the database is at a location remote from the computer and accessible by the software program via a network.

9. A key management system as in claim 8, wherein the network is the Internet.

10. A key management system as in claim 8, wherein the computer includes a local data buffer for storing key management data downloaded from the database.

11. A key management system as in claim 8, wherein the computer includes a local data buffer for storing audit trails data downloaded from the electronic key.

12. A key management system as in claim 1, wherein the software program includes computer-executable instructions for retrieving operation limit parameters for electronic key from the database, performing a calculation to formulate a new limit parameter, and store the new limit parameter in the electronic key.

13. A key management system as in claim 1, wherein the electronic lock is placed in a learning mode, an access code is transferred to the electronic lock, and the access code is written into a memory of the electronic lock.

14. A key management system for management of electronic keys used to access electronic locks, comprising:
an electronic key including operation limit parameters for determining if the shall be rendered disabled in accessing the electronic locks, and a memory for storing audit trails data collected from electronic locks accessed using said key:
a computer having a software program for key management functionality;
a database containing key management data; and
a cradle communicating with the computer for interfacing the computer with an electronic key;
the software program having computer-executable instructions for allowing a user to modify key operation limit parameters and store key operation limit parameters in the database during a first operation mode, and for restricting a user from modifying key operation limit parameters and storing key operation limit parameters during a second operation mode, and for performing a key refresh operation with the steps of:
receiving a transmission from a key through the cradle and receiving a key identification number from the key through the cradle;
receiving the audit trails from the key, and storing the received audit trails data into the database;
retrieving from the database operation limit parameters based on the key identification number: and
sending the operation limit parameters through the cradle to the key.

15. A key management system as in claim 14, wherein the database contains a unique authorization number.

16. A key management system as in claim 14, wherein the computer receives an
initial transmission from a key through the cradle, the initial transmission initiating the key refreshing operation.

17. A key management system as in claim 14, wherein the key and cradle engage in encrypted challenge-response communication.

18. A key management system as in claim 14, wherein the software program includes computer-executable instructions for presenting a user interface screen for prompting an authorized user to set operation limit parameters for an electronic key, and saving the operation limit parameters for the electronic key into the database.

19. A key management system as in claim 14, wherein the software program includes computer-executable instructions for presenting a user interface screen for a system administrator to add or delete a user having authority for selling operation limit parameters for electronic keys.

20. A key management system as in claim 14, wherein the database is at a location remote from the computer and accessible by the software program via a network.

21. A key management system as in claim 20, wherein the network is the Internet.

22. A key management system as in claim 20, wherein the computer includes a local data buffer for storing key management data downloaded from the database.

23. A key management system as in claim 20, wherein the computer includes a local data buffer for storing audit trails data downloaded from the electronic key.

24. A key management system as in claim 14, wherein the software program includes computer-executable instructions for retrieving operation limit parameters for electronic key from the database, performing a calculation to formulate a new limit parameter, and store the new limit parameter in the electronic key.

25. A key management system as in claim 14, wherein the software program includes computer-executable instructions for obtaining a lock identification number from the database and transferring the lock identification number to the electronic key.

26. A key management system as in claim 14, wherein the electronic lock is placed in a learning mode, an access code is transferred to the electronic lock, and the access code is written into a memory of the electronic lock.

27. A key management system for management of electronic keys used to access electronic locks, comprising:
an electronic key including operation limit parameters for determining if the key shall be rendered disabled in accessing the electronic locks, and a memory for storing audit trails data collected from electronic locks accessed using said key;
a plurality of key management stations including at least first and second key management stations, each key management station having a computer with a software program for key management functionality and a cradle communicating with the computer for interfacing the computer with an electronic key, the first and second key management stations both having access to a shared database containing the key management data, the first key management station having a first database address pointer and the second key management stations having a second database address pointer that is the same as the first database address pointer;
the software program on the computer of either key management station having computer-executable instructions for:
receiving the audit trails from the key, and storing the received audit trails data into the shared database;
receiving operation limit parameters designated to a key identification number from the shared database, sending the operation limit parameters to the electronic key.

28. A key management system as in claim 27, wherein the database contains a unique authorization code.

29. A key management system as in claim 27, wherein the computer receives an
initial transmission from a key through the cradle, the initial transmission initiating the key refreshing operation.

30. A key management system as in claim 27, the software program further comprising computer-executable instructions for allowing a user to modify key operation limit parameters during a first operation mode, and for restricting a user from modifying key operation limit parameters during a second operation mode.

31. A key management system as in claim 27, wherein the key and cradle engage in encrypted challenge-response communication.

32. A key management system as in claim 27, wherein the computer further employs an operating system for operating a plurality of tasks, wherein at least one task comprising the software program for performing the key refreshing operation.

33. A key management system as in claim 27, wherein the software program includes computer-executable instructions for presenting a user interface screen for prompting an authorized user to set operation limit parameters for an electronic key, and saving the operation limit parameters for the electronic key into the database.

34. A key management system as in claim 27, wherein the software program includes computer-executable instructions for presenting a user interface screen for a system administrator to add or delete a user having authority for setting operation limit parameters for electronic keys.

35. A key management system as in claim 27, wherein the database is at a location remote from the computer and accessible by the software program via a network.

36. A key management system as in claim 35, wherein the network is the Internet.

37. A key management system as in claim 35, wherein the computer includes a local data buffer for storing key management data downloaded from the database.

38. A key management system as in claim 35, wherein the computer includes a local data buffer for storing audit trails data downloaded from the electronic key.

39. A key management system as in claim 27, wherein the software program includes computer-executable instructions for retrieving operation limit parameters for electronic key from the database, performing a calculation to formulate a new limit parameter, and store the new limit parameter in the electronic key.

40. A key management system as in claim 27, where the software program includes computer-executable instructions for obtaining a lock identification number from the database and transferring the lock identification number to the electronic key.

41. A key management system as in claim 27, wherein the electronic lock is placed in a learning mode, an access code is transferred to the electronic lock, and the access code is written into a memory of the electronic lock.

42. A key management system for management of electronic keys used to access electronic locks, comprising:
an electronic key including a plurality of unique lock identification numbers for determining if the key shall be authorized in accessing the electronic locks, and a memory for storing audit trails data collected from electronic locks accessed using said key;
a plurality of key management stations including at least first and second key management stations, each key management station having a computer with a software program for key management functionality and a cradle communicating with the computer for interfacing the computer with an electronic key, the first and second key management stations both having access to a shared database containing the key management data, the first key management station having a first database address pointer and the second key management stations having a second database address pointer that is the same as the first database address pointer;
the software program on the computer of either key management station having computer-executable instructions for:
receiving the audit trails from the key, and storing the received audit trails data into the shared database;
obtaining a plurality of lock identification numbers from the shared database;
send the lock identification numbers to the electronic key, whereby the lock identification numbers are stored in a memory of the electronic key.

43. A key management system as in claim 42, wherein the database contains a unique authorization code.

44. A key management system as in claim 42, wherein the computer receives an initial transmission from a key through the cradle, the initial transmission initiating the key refreshing operation.

45. A key management system as in claim 42, wherein the key and cradle engage in encrypted challenge-response communication.

46. A key management system as in claim 42, wherein the computer further employs an operating system for operating a plurality of tasks, wherein at least one task comprising the software program for performing the key refreshing operation.

47. A key management system as in claim 42 wherein the software program includes computer-executable instructions for presenting a user interface screen for a system administrator to add or delete a user having authority for setting operation limit parameters for electronic keys.

48. A key management system as in claim 42, wherein the database is at a location remote from the computer and accessible by the software program via a network.

49. A key management system as in claim 48, wherein the network is the Internet.

50. A key management system as in claim 48, wherein the computer includes a local data buffer for storing key management data downloaded from the database.

51. A key management system as in claim 48, wherein the software program includes computer-executable instructions for selecting and displaying operation limit parameters for a plurality of electronic keys.

52. A key management system as in claim 42, wherein the software program includes computer-executable instructions for retrieving operation limit parameters for electronic key from the database, performing a calculation to formulate a new limit parameter, and store the new limit parameter in the electronic key.

53. A key management system as in claim 42, wherein the electronic lock is placed in a learning mode, an access code is transferred to the electronic lock, and the access code is written into a memory of the electronic lock.

54. A key management system for management of electronic keys used to access electronic locks, comprising:
an electronic key including a plurality of unique lock identification numbers for determining if the key shall be authorized in accessing the electronic locks, and a memory for storing audit trails data collected from electronic locks accessed using said key;
a computer employing an operating system for operating a plurality of tasks, wherein at least one task being a software program for key management functionality;
a database containing key management data; and
a cradle communicating with the computer for interfacing the computer with an electronic key;
the software program having computer-executable instructions for performing a key refreshing operation, said operation consisting of one of the plurality of tasks operating with the steps of:
receiving a transmission from a key through the cradle and receiving a key identification number from the key through the cradle;
receiving the audit trails from the key and storing the received audit trails data into the shared database;
obtaining from the database, a plurality of lock identification numbers,
sending the lock identification numbers to the electronic key, whereby the lock identification numbers are stored in a memory of the electronic key.

55. A key management system as in claim 54, wherein the database contains a unique authorization code.

56. A key management system as in claim 54, wherein the computer receives an initial transmission from a key through the cradle, the initial transmission initiating the key refreshing operation.

57. A key management system as in claim 54, wherein the key and cradle engage in encrypted challenge-response communication.

58. A key management system as in claim 54, wherein the software program includes computer-executable instructions for presenting a user interface screen for a system administrator to add or delete a user having authority for setting operation limit parameters for electronic keys.

59. A key management system as in claim 54, wherein the database is at a location remote from the computer and accessible by the software program via a network.

60. A key management system as in claim 59, wherein the network is the Internet.

61. A key management system as in claim 59, wherein the computer includes a local data buffer for storing key management data downloaded from the database.

62. A key management system as in claim 59, wherein the computer includes a local data buffer for storing audit trails data downloaded from the electronic key.

63. A key management system as in claim 54, wherein the software program includes computer-executable instructions for retrieving operation limit parameters for electronic key from the database, performing a calculation to formulate a new limit parameter, and store the new limit parameter in the electronic key.

64. A key management system as in claim 54, wherein the electronic lock is placed in a learning mode, an access code is transferred to the electronic lock, and the access code is written into a memory of the electronic key.

65. A key management system for management of electronic keys used to access electronic locks, comprising:
an electronic key including a plurality of unique lock identification numbers determining if the key shall be authorized in accessing the electronic locks, operation limit parameters for determining if the key shall be rendered disabled in accessing the electronic locks, and audit trails data collected from vending-machines accessed using said key, and;
a computer having a software program for key management functionality:
a database containing key management data; and
a cradle communicating with the computer for interfacing the computer with an electronic key:
the software program having computer-executable instructions for performing a key refresh operation with the steps of:
receiving a transmission from a key through the cradle and receiving a key identification number from the key through the cradle;
receiving the audit trails from the key, and storing the received audit trails data into the database,
obtaining from the database, a plurality of lock identification numbers,
sending the lock identification numbers to the electronic key, whereby the lock
identification numbers are stored in a memory of the electronic key;
retrieving from the database operation limit parameters based on the key identification number, and
sending the operation limit parameters through the cradle to the key.

66. A key management system as in claim 65, wherein the database contains a unique authorization code.

67. A key management system as in claim 65, wherein the computer receives an
initial transmission from a key through the cradle, the initial transmission initiating the key refreshing operation.

68. A key management system as in claim 65, the software program further comprising computer-executable instructions for allowing a user to modify key operation limit parameters during a first operation mode, and for restricting a user from modifying key operation limit parameters during a second operation mode.

69. A key management system as in claim 65, wherein the key and cradle engage in encrypted challenge-response communication.

70. A key management system as in claim 65, wherein the computer further employs an operating system for operating a plurality of tasks, wherein at least one task comprising the software program for performing the key refreshing operation.

71. A key management system as in claim 65, wherein the software program includes computer-executable instructions for presenting a user interface screen for prompting an authorized user to set operation limit parameters for an electronic key, and saving the operation limit parameters for the electronic key into the database.

72. A key management system as in claim 65, wherein the software program includes computer-executable instructions for presenting a user interface screen for a system administrator to add or delete a user having authority for setting operation limit parameters for electronic keys.

73. A key management system as in claim 65, wherein the database is at a location remote from the computer and accessible by the software program via a network.

74. A key management system as in claim 73, wherein the network is the Internet.

75. A key management system as in claim 73, wherein the computer includes a local data buffer for storing key management data downloaded from the database.

76. A key management system as in claim 73, wherein the computer includes a local data buffer for storing audit trails data downloaded from the electronic key.

77. A key management system as in claim 65, wherein the software program includes computer-executable instructions for retrieving operation limit parameters for electronic key from the database, performing a calculation to formulate a new limit parameter, and store the new limit parameter in the electronic key.

78. A key management system as in claim 65, wherein the electronic lock is placed in a learning mode, an access code is transferred to the electronic lock, and the access code is written into a memory of the key.
